(19) United States
(12) Patent Application Publication
(10) Pub. No.: US 2026/0077243 A1
(43) Pub. Date: Mar. 19, 2026

(54) GOLF BALL

(71) Applicant: BRIDGESTONE SPORTS CO., LTD., Tokyo (JP)

(72) Inventors: Hideo WATANABE, Chichibushi (JP); Akira Kimura, Chichibushi (JP); Hirotaka Shinohara, Chichibushi (JP); Yuki Mizuno, Chichibushi (JP)

(73) Assignee: BRIDGESTONE SPORTS CO., LTD., Tokyo (JP)

(21) Appl. No.: 19/312,703

(22) Filed: Aug. 28, 2025

(30) Foreign Application Priority Data
Sep. 19, 2024 (JP) 2024-162381

(51) Int. Cl. A63B 37/00; C08L 9/00

(52) U.S. Cl. CPC A63B 37/0063; A63B 37/00621; A63B 37/00622; A63B 37/0065; A63B 37/0074; A63B 37/0075; C08L 9/00; A63B 2209/00; C08L 2201/08; C08L 2312/00

(57) ABSTRACT

Provided is a golf ball including a single-layer core and a cover, wherein the core has a hardness profile in which, letting a Shore C hardness of a core surface be H100, Shore C hardnesses of an 87.5% outer position, a 75% outer position, a 62.5% outer position, a 50% outer position, a 37.5% outer position, a 25% outer position, and a 12.5% outer position of a core radius from a core center be H87.5, H75, H62.5, H50, H37.5, H25, and H12.5, respectively, and a Shore C hardness of the core center be H0, the following two conditions are satisfied:

$$0 \leq ( H 62.5 - H 50 ) < ( H 100 - H 87.5 ) < ( H 87.5 - H 75 ) < ( H 75 - H 62.5 ) \leq 7. , and$$

$$( H 87.5 - H 50 ) / ( H 50 - H 12.5 ) \geq 3.0 .$$

### CROSS-REFERENCE TO RELATED APPLICATIONS

This non-provisional application claims priority under 35 U.S.C. § 119 (a) on Patent Application No. 2024-162381 filed in Japan on Sep. 19, 2024, the entire contents of which are hereby incorporated by reference.

### TECHNICAL FIELD

The present invention relates to a golf ball for professionals and advanced players including a single-layer core and a cover.

### BACKGROUND ART

As golf balls for professionals and advanced players, solid golf balls such as two-piece solid golf balls and three-piece solid golf balls are often used. A solid golf ball usually has a structure in which a core of a rubber composition is encased in a single-layer or multilayer cover made of various resin materials, but the core occupies most of the volume of the golf ball, and has a large influence on various physical properties of the ball such as rebound, feel at impact, and durability. Recently, various techniques have been proposed in which a unique core hardness inclination is realized by appropriately adjusting the cross-sectional hardness of the core, and a distance is improved by optimizing spin characteristics on full shots with a driver or an iron. Further, as a golf ball for advanced players and professionals, a polyurethane cover is often used as an outermost layer. It is also important to improve durability to cracking on repeated impact of a golf ball having such a structure.

Examples of a method for adjusting the cross-sectional hardness of the core include appropriately adjusting blending components of the rubber composition of the core, a vulcanization temperature, and a vulcanization time. For example, the following Patent Documents 1 to 27 provide a specific core internal cross-sectional hardness by selecting the type and compounding amount of a co-crosslinking agent and an organic peroxide for the blending components of the rubber composition of the core, and blending water, an organosulfur compound, or the like as another component.

However, the golf balls described in these patent documents still have problems in satisfying all of a flight on full shots, controllability in the short game, and durability to cracking on repeated impact that satisfy professionals and advanced players.

### CITATION LIST

Patent Document 1: JP-A 2011-120898
Patent Document 2: JP-A 2013-230361
Patent Document 3: JP-A 2013-230362
Patent Document 4: JP-A 2013-230363
Patent Document 5: JP-A 2015-077405
Patent Document 6: JP-A 2013-230365
Patent Document 7: JP-A 2016-112308
Patent Document 8: JP-A 2016-116627
Patent Document 9: JP-A 2016-179052
Patent Document 10: JP-A 2017-000183
Patent Document 11: JP-A 2017-000470
Patent Document 12: JP-A 2017-077355
Patent Document 13: JP-A 2017-079905
Patent Document 14: JP-A 2019-198465
Patent Document 15: JP-A 2019-213606
Patent Document 16: JP-A 2021-062026
Patent Document 17: JP-A 2021-062036
Patent Document 18: JP-A 2011-217857
Patent Document 19: JP-A 2012-019820
Patent Document 20: JP-A 2012-010726
Patent Document 21: US 2013/0157781
Patent Document 22: JP-A 2015-006314
Patent Document 23: JP-A 2013-009814
Patent Document 24: JP-A 2013-031640
Patent Document 25: JP-A 2013-248298
Patent Document 26: JP-A 2023-175347
Patent Document 27: JP-A 2023-031970

### SUMMARY OF THE INVENTION

The present invention has been made in view of the above circumstances, and an object of the present invention is to provide a golf ball that achieves both flight performance and durability on repeated impact at a high level as a golf ball for professionals and advanced players.

As a result of intensive studies to achieve the above object, the present inventor has found that, for a golf ball including a single-layer core and a cover, the core has a hardness profile in which, letting a Shore C hardness at a core surface be H100, a Shore C hardness at a position outside by 87.5% of a core radius from a core center be H87.5, a Shore C hardness at a position outside by 75% of the core radius from the core center be H75, a Shore C hardness at a position outside by 62.5% of the core radius from the core center be H62.5, a Shore C hardness at a position outside by 50% of the core radius from the core center be H50, a Shore C hardness at a position outside by 37.5% of the core radius from the core center be H37.5, a Shore C hardness at a position outside by 25% of the core radius from the core center be H25, a Shore C hardness at a position outside by 12.5% of the core radius from the core center be H12.5, and a Shore C hardness at the core center be H0, the following two conditions are satisfied:

$$0 \leq ( H 62.5 - H 50 ) < ( H 100 - H 87.5 ) < ( H 87.5 - H 75 ) < ( H 75 - H 62.5 ) \leq 7. , and$$

$$( H 87.5 - H 50 ) / ( H 50 - H 12.5 ) \geq 3.0$$

and the present inventor has found that by configuring the golf ball so as to satisfy the above conditions, a professional or an advanced player can achieve a low spin of the ball on full shots, can sufficiently extend a distance on shots with a driver (W #1) and an iron, has excellent durability on repeated impact, and further, can obtain high spin controllability on approach shots in the short game, and has completed the present invention.

That is, in the golf ball of the present invention, attention is particularly focused on the core hardness profile, and by improving the core hardness profile, by reducing the spin on full shots, a high head speed range has an excellent distance on shots with a driver (W #1), and also has a good distance on shots with an iron. In the core hardness profile in the present invention, the core radius of the surface is divided into eight equal parts from the center of a core cross-section, and the core hardness profile has been defined by parameters obtained based on a total of nine measurement points. In addition, by improving not only a hardness profile shape of an entire core but also a hardness profile shape from an intermediate point between the surface and the center of the core to the surface of the core, specifically, by setting a hardness gradient from a position of 62.5% of the core radius to the surface direction to be gradually gentle, excellent durability on repeated impact has been achieved. The golf ball of the present invention also imparts spin performance in the short game that can satisfy professional advanced players.

Accordingly, the present invention provides a golf ball including
a single-layer core and a cover, wherein the core has a hardness profile in which, letting a Shore C hardness of a surface of the core be H100, a Shore C hardness at a position outside by 87.5% of a core radius from a core center be H87.5, a Shore C hardness at a position outside by 75% of the core radius from the core center be H75, a Shore C hardness at a position outside by 62.5% of the core radius from the core center be H62.5, a Shore C hardness at a position outside by 50% of the core radius from the core center be H50, a Shore C hardness at a position outside by 37.5% of the core radius from the core center be H37.5, a Shore C hardness at a position outside by 25% of the core radius from the core center be H25, a Shore C hardness at a position outside by 12.5% of the core radius from the core center be H12.5, and a Shore C hardness at the core center be H0, the following two conditions are satisfied:

$$0 \leq ( H 62.5 - H 50 ) < ( H 100 - H 87.5 ) < ( H 87.5 - H 75 ) < ( H 75 - H 62.5 ) \leq 7. , and$$

$$( H 87.5 - H 50 ) / ( H 50 - H 12.5 ) \geq 3.0$$

In a preferred embodiment of the golf ball according to the invention, the following condition is satisfied:

$$( H 100 - H 87.5 ) / ( H 87.5 - H 75 ) \leq 0.90 .$$

In another preferred embodiment of the inventive golf ball, the following condition is satisfied:

$$0.5 \leq ( H 8 7.5 - H 75 ) / ( H 75 - H 62.5 ) \leq 0.99 .$$

In yet another preferred embodiment, the following condition is satisfied:

$$1. \leq ( H 100 - H 87.5 ) \leq 6.0 .$$

In still another preferred embodiment, the following condition is satisfied:

$$2. \leq ( H 8 7.5 - H 75 ) \leq 6.5 .$$

In a further preferred embodiment, the following condition is satisfied:

$$4. \leq ( H 75 - H 62.5 ) \leq 7.0 .$$

In a yet further preferred embodiment, the following condition is satisfied:

$$0 \leq ( H 62.5 - H 50 ) \leq 3.0 .$$

In a still further embodiment, the following condition is satisfied:

$$0 \leq ( H 50 - H 25 ) \leq 3.0 .$$

In another preferred embodiment, values of the following eight conditions are all
positive values:
H100−H87.5,
H87.5−H75,
H75−H62.5,
H62.5−H50,
H50−H37.5,
H37.5−H25,
H25−H12.5, and
H12.5−H0.

In another preferred embodiment, the core is formed of a rubber composition including the following components (a) to (e):
(a) a base rubber,
(b) an α,β-unsaturated carboxylic acid and/or a metal salt thereof as a co-crosslinking agent,
(c) an organic peroxide,
(d) water or a moisture-providing agent, and
(e) a hindered phenol-based antioxidant having a substituent having a thioether structure, the moisture-providing agent being a substance that contains a water component other than free water in a structure thereof and desorbs moisture by heating, or a substance that releases a water component by thermal decomposition by heating, a compounding amount of the component (e) being at least 0.2 parts by weight per 100 parts by weight of the component (a).

In yet another preferred embodiment, the hindered phenol-based antioxidant that is the component (e) has a chemical structure having at least one methyl group at an ortho position.

In still another preferred embodiment, the hindered phenol-based antioxidant that is the component (e) has at least two substituents having a thioether structure.

In a further preferred embodiment, a deflection when the core is compressed under a final load of 1,275 N (130 kgf) from an initial load of 98 N (10 kgf) is not more than 3.8 mm.

In a yet further preferred embodiment, when a deflection when the core is compressed under a final load of 1,275 N (130 kgf) from an initial load of 98 N (10 kgf) is A (mm), and a deflection when the golf ball is compressed under a final load of 1,275 N (130 kgf) from an initial load of 98 N (10 kgf) is B (mm), a value of A-B is less than 1.0 mm.

In a still further preferred embodiment, the golf ball is a three-piece or more golf ball including a resin intermediate layer interposed between the core and the cover, wherein a relationship between a surface hardness of a sphere (intermediate layer-encased sphere) obtained by encasing the core with the intermediate layer and a surface hardness of the ball satisfies the following condition:

(Shore D hardness of surface of intermediate layer-encased sphere)−(Shore D hardness of surface of ball)≥3.

### Advantageous Effects of the Invention

With the golf ball of the present invention, as a golf ball for professionals and advanced players, it is possible to realize low spin on full shots and secure a superior distance, and the golf ball has good controllability in the short game and high durability on repeated impact.

### BRIEF DESCRIPTION OF THE DRAWINGS

FIG. 1 is a schematic cross-sectional view of a golf ball according to one embodiment of the present invention;

FIG. 2 is a graph showing core hardness profile data in Example 1;

FIGS. 3A and 3B are plan views illustrating a mode (pattern) of dimples common to Examples and Comparative Examples;

FIG. 4 is a graph showing core hardness profiles in Examples 1 to 3 and Comparative Examples 1 to 3; and

FIG. 5 is a graph showing core hardness profiles in Comparative Examples 4 to 9.

### DETAILED DESCRIPTION OF THE INVENTION

Hereinafter, the present invention is described in more detail.

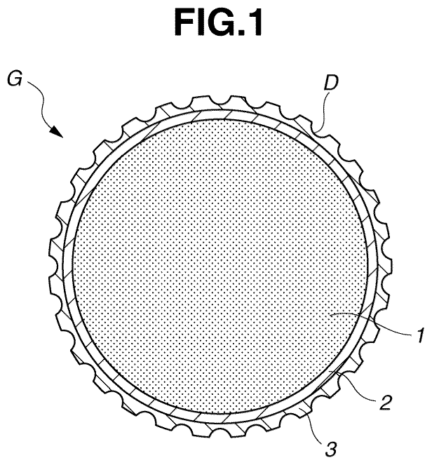

A golf ball according to the present invention has a single-layer core and a cover, and an example thereof is shown in FIG. 1, for example. A golf ball G shown in FIG. 1 has a single-layer core 1 and a single-layer cover 3, and further has a single-layer intermediate layer 2 therebetween. The cover 3 is positioned at an outermost layer in a layer structure of the golf ball except for a coating layer. The core is formed in a single layer as illustrated in FIG. 1, and the cover is formed in a single layer as illustrated in FIG. 1. In addition, a single layer or a plurality of surrounding layers composed of resin may be formed between the intermediate layer and the core. A large number of dimples D are typically formed on a surface of the cover (outermost layer) 3 in order to improve aerodynamic properties of the ball. In addition, although not particularly illustrated, the coating layer is typically formed on the surface of the cover 3. Hereinafter, each of the above layers is described in detail.

The core is formed in a single layer. In the case of a core made of a plurality of layers of rubber, peeling occurs from an interface when the core is repeatedly struck, and durability may worsen.

The diameter of the core is not particularly limited, although the diameter is preferably at least 37.0 mm, more preferably at least 38.0 mm, and still more preferably at least 38.3 mm. The upper limit thereof is preferably not more than 39.7 mm, more preferably not more than 39.3 mm, and still more preferably not more than 39.0 mm. If the diameter of the core is too small, a hardness of an entire ball is too hard, that is, if a deflection becomes small, a spin rate on full shots increases, and a target distance may not be obtained. On the other hand, if the diameter of the core is too large, the spin rate on full shots increases, and a target distance may not be obtained.

The deflection (mm) when the core is compressed under a final load of 1,275 N (130 kgf) from an initial load of 98 N (10 kgf) is not particularly limited, although the deflection is preferably at least 2.7 mm, more preferably at least 2.9 mm, and even more preferably at least 3.1 mm, and the upper limit thereof is preferably not more than 3.8 mm, more preferably not more than 3.7 mm, and even more preferably not more than 3.65 mm. If the deflection of the core is too small, that is, the core is too hard, the spin may rise excessively, a good distance may not be achieved, and a feel at impact may be excessively hard. On the other hand, if the deflection of the core is too large, that is, the core is too soft, a rebound may become too low and the distance may not be increased, the feel at impact may be too soft, and the durability to cracking on repeated impact may worsen.

Next, a core hardness profile is described. Note that the hardness of the core described below means Shore C hardness. The Shore C hardness is a hardness value measured with a Shore C durometer conforming to the ASTM D2240 standard.

In the following description of the core hardness profile, the Shore C hardness of a core surface is defined as H100, a Shore C hardness at a position outside by 87.5% of a core radius from a core center is defined as H87.5, a Shore C hardness at a position outside by 75% of the core radius from the core center is defined as H75, a Shore C hardness at a position outside by 62.5% of the core radius from the core center is defined as H62.5, a Shore C hardness at a position outside by 50% of the core radius from the core center is defined as H50, a Shore C hardness at a position outside by 37.5% of the core radius from the core center is defined as H37.5, a Shore C hardness at a position outside by 25% of the core radius from the core center is defined as H25, a Shore C hardness at a position outside by 12.5% of the core radius from the core center is defined as H12.5, and the Shore C hardness at the core center is defined as H0.

The surface hardness (H100) of the core is not particularly limited, although the surface hardness may be preferably at least 79, more preferably at least 81, and still more preferably at least 83. In addition, although not particularly limited, an upper limit thereof may be preferably not more than 92, more preferably not more than 90, and even more preferably not more than 88. If this value is too small, the rebound of the core becomes too low, the spin rate of the ball on full shots increases, and a target distance may not be obtained. On the other hand, if this value is too large, the durability to cracking on repeated impact may worsen, and the feel at impact may be too hard.

The position hardness (H87.5) outside by 87.5% of the radius from the core center is not particularly limited, although the position hardness may be preferably at least 76, more preferably at least 78, and still more preferably at least 80. The upper limit thereof is also not particularly limited, although the upper limit may be preferably not more than 88, more preferably not more than 86, and still more preferably not more than 84. Hardnesses that deviate from these values may lead to undesirable results similar to those described above for the core surface hardness (H100).

The position hardness (H75) outside by 75% of the radius from the core center is not particularly limited, although the position hardness may be preferably at least 71, more preferably at least 73, and still more preferably at least 75. The upper limit thereof is also not particularly limited, although the upper limit may be preferably not more than 83, more preferably not more than 81, and still more preferably not more than 79. Hardnesses that deviate from these values may lead to undesirable results similar to those described above for the core surface hardness (H100).

The position hardness (H62.5) outside by 62.5% of the radius from the core center is not particularly limited, although the position hardness may be preferably at least 64, more preferably at least 66, and still more preferably at least 68. The upper limit thereof is also not particularly limited, although the upper limit may be preferably not more than 77, more preferably not more than 75, and still more preferably not more than 73. Hardnesses that deviate from these values may lead to undesirable results similar to those described above for the core surface hardness (H100).

The position hardness (H50) outside by 50% of the radius from the core center is not particularly limited, although the position hardness may be preferably at least 64, more preferably at least 66, and still more preferably at least 68. The upper limit thereof is also not particularly limited, although the upper limit may be preferably not more than 77, more preferably not more than 75, and still more preferably not more than 73. Hardnesses that deviate from these values may lead to undesirable results similar to those described above for the core surface hardness (H100).

The position hardness (H37.5) outside by 37.5% of the radius from the core center is not particularly limited, although the position hardness may be preferably at least 64, more preferably at least 66, and still more preferably at least 68. The upper limit thereof is also not particularly limited, although the upper limit may be preferably not more than 77, more preferably not more than 75, and still more preferably not more than 73. If this value is too small, the rebound of the core may be lowered and a target distance may not be obtained, or the durability to cracking on repeated impact may worsen. If this value is too large, the spin rate of the ball increases and a target distance may not be obtained, or the feel at impact may become too hard.

The position hardness (H25) outside by 25% of the radius from the core center is not particularly limited, although the position hardness may be preferably at least 63, more preferably at least 65, and still more preferably at least 67. The upper limit thereof is also not particularly limited, although the upper limit may be preferably not more than 76, more preferably not more than 74, and still more preferably not more than 72. Hardnesses that deviate from these values may lead to undesirable results similar to those described above for the position hardness (H37.5) outside by 37.5% of the radius from the core center.

The position hardness (H12.5) outside by 12.5% of the radius from the core center is not particularly limited, although the position hardness may be preferably at least 62, more preferably at least 64, and still more preferably at least 66. The upper limit thereof is also not particularly limited, although the upper limit may be preferably not more than 75, more preferably not more than 73, and still more preferably not more than 71. Hardnesses that deviate from these values may lead to undesirable results similar to those described above for the position hardness (H37.5) outside by 37.5% of the radius from the core center.

The center hardness (H0) of the core is not particularly limited, although the center hardness may be preferably at least 59, more preferably at least 61, and still more preferably at least 63. The upper limit thereof is also not particularly limited, although the upper limit may be preferably not more than 72, more preferably not more than 71, and still more preferably not more than 70. Hardnesses that deviate from these values may lead to undesirable results similar to those described above for the position hardness (H37.5) outside by 37.5% of the radius from the core center.

A value of a hardness difference (H75−H62.5) between H75 and H62.5 preferably satisfies the following condition.

$$( H 75 - H 62.5 ) \leq 7.0 \qquad ( i )$$

The value of (H75−H62.5) in the above condition is preferably at least 4.0, more preferably at least 4.5, and still more preferably at least 5.0, and the upper limit thereof is preferably not more than 7.0, more preferably not more than 6.8, and still more preferably not more than 6.5. If this value is too large, the durability to cracking on repeated impact may worsen. On the other hand, if this value is too small, the spin rate of the ball on full shots increases, and the distance may not be increased.

In addition, it is preferable to satisfy the following condition.

$$( H 87.5 - H 75 ) < ( H 75 - H 62.5 ) \qquad ( ii )$$

If the above condition is not satisfied, the durability to cracking on repeated impact may worsen.

In addition, it is preferable to satisfy the following condition.

$$( H 100 - H 87.5 ) < ( H 87.5 - H 75 ) \qquad ( iii )$$

If the above condition is not satisfied, the durability to cracking on repeated impact may worsen.

In addition, it is preferable to satisfy the following condition.

$$( H 62.5 - H 50 ) < ( H 100 - H 87.5 ) \qquad ( iv )$$

If the above condition is not satisfied, the spin rate of the ball on full shots may increase, and a target distance may not be obtained.

Further, the following condition is preferably satisfied.

$$( H 62.5 - H 50 ) \geq 0 \qquad ( v )$$

If the above condition is not satisfied, the spin rate of the ball on full shots may increase, and a target distance may not be obtained. The value of (H62.5−H50) in the above condition is preferably at least 0, more preferably at least 0.1, and still more preferably at least 0.2, and the upper limit thereof is preferably not more than 3.0, more preferably not more than 2.0, and still more preferably not more than 1.0.

The above (i) to (v) are expressed by one condition as follows.

$$0 \leq ( H 62.5 - H 50 ) < ( H 100 - H 87.5 ) < ( H 8 7.5 - H 75 ) < ( H 75 - H 62.5 ) \leq 7.0$$

That is, the above condition means that a hardness gradient from a position of 62.5% of the core radius from the core center to the surface direction gradually becomes gentle.

The value of (H100−H87.5) in the above condition is preferably at least 1.0, more preferably at least 2.0, and still more preferably at least 3.0, and the upper limit thereof is preferably not more than 6.0, more preferably not more than 5.0, and still more preferably not more than 4.0. If this value is too large, the durability to cracking on repeated impact may worsen. On the other hand, if this value is too small, the spin rate of the ball on full shots increases, and the distance may not be increased.

The value of (H87.5−H75) in the above condition is preferably at least 2.0, more preferably at least 3.5, and still more preferably at least 5.0, and the upper limit thereof is preferably not more than 6.5, more preferably not more than 6.3, and still more preferably not more than 6.2. If this value is too large, the durability to cracking on repeated impact may worsen. On the other hand, if this value is too small, the spin rate of the ball on full shots increases, and the distance may not be increased.

The value of (H100−H87.5)/(H87.5−H75) is preferably at least 0.35, more preferably at least 0.45, and still more preferably at least 0.55, and the upper limit thereof is preferably not more than 0.90, more preferably not more than 0.80, and still more preferably not more than 0.70. That is, the hardness gradient from H87.5 to H100 is gentler than the hardness gradient from H75 to H87.5. If this value is too large, the durability to cracking on repeated impact may worsen. On the other hand, if this value is too small, the spin rate of the ball on full shots may increase, and a target distance may not be obtained.

The value of (H87.5−H75)/(H75−H62.5) is preferably at least 0.50, more preferably at least 0.60, and still more preferably at least 0.70, and the upper limit thereof is preferably not more than 0.99, more preferably not more than 0.95, and still more preferably not more than 0.90. That is, the hardness gradient from H75 to H87.5 is gentler than the hardness gradient from H62.5 to H75. If this value is too large, the durability to cracking on repeated impact may worsen. On the other hand, if this value is too small, the spin rate of the ball on full shots may increase, and a target distance may not be obtained.

The value of (H87.5−H50)/(H50−H12.5) is preferably at least 3.0, more preferably at least 3.4, and still more preferably at least 3.8, and the upper limit thereof is preferably not more than 15.0, more preferably not more than 10.0, and still more preferably not more than 8.0. If this value is too large, the durability to cracking on repeated impact may worsen. On the other hand, if this value is too small, the spin rate of the ball on full shots may increase, and a target distance may not be obtained.

The value of (H100−H50)/(H50−H0) is preferably at least 2.0, more preferably at least 2.5, and still more preferably at least 2.8, and the upper limit thereof is preferably not more than 15.0, more preferably not more than 10.0, and still more preferably not more than 8.0. If this value is too large, the durability to cracking on repeated impact may worsen. On the other hand, if this value is too small, the spin rate of the ball on full shots may increase, and a target distance may not be obtained.

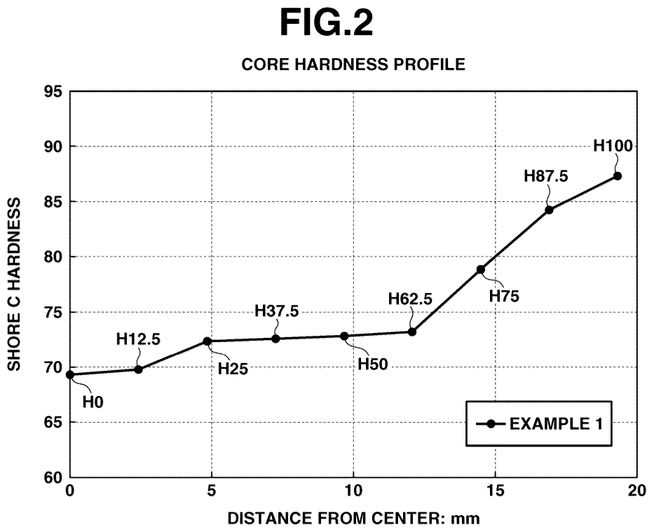

It is preferable that all values of the hardness differences among a total of nine points obtained by dividing the core radius of the surface from the center of the core cross-section into eight equal parts, that is, all the values of (H100−H87.5), (H87.5−H75), (H75−H62.5), (H62.5−H50), (H50−H37.5), (H37.5−H25), (H25−H12.5), and (H12.5−H0), are positive values. That is, an increase continues from the center of the core toward the surface and there is no place where the hardness decreases. For example, FIG. 2 shows core hardness profile data of Example 1. As shown in this graph, the hardness gradient is upward sloping without being indented. In a case where all of these values are not positive values, the spin rate of the ball on full shots increases, and a target distance may not be obtained.

As a material of the core having the hardness profile described above, a rubber material is preferably used as a chief material. If the core is not formed of a rubber material, rebound may be reduced, and a good distance of the ball may not be achieved. Specifically, the rubber material contains a base rubber as a chief material, and a co-crosslinking agent, an organic peroxide, an inert filler, an organosulfur compound, or the like may be blended with the base rubber to prepare a rubber composition for the core.

The rubber material preferably contains the following components (a) to (e):
(a) a base rubber,
(b) an α,β-unsaturated carboxylic acid and/or a metal salt thereof as a co-crosslinking
agent,
(c) an organic peroxide,
(d) water or a moisture-providing agent, and
(e) a hindered phenol-based antioxidant having a substituent having a thioether structure.

The base rubber of the above component (a) is not particularly limited, although polybutadiene is particularly preferably used.

The polybutadiene suitably has at least 60%, preferably at least 80%, more preferably at least 90%, and most preferably at least 95% of a cis-1,4 bond in a polymer chain thereof. If the cis-1,4 bond occupying a bond in a polybutadiene molecule is too small, rebound may be reduced.

In addition, the content of a 1,2-vinyl bond contained in the polybutadiene is usually not more than 2%, preferably not more than 1.7%, and still more preferably not more than 1.5% in the polymer chain. If the content of the 1,2-vinyl bond is too large, rebound may be reduced.

In the polybutadiene, (ML1+4 (100° C.)) is preferably at least 20, and more preferably at least 30, and the upper limit thereof is preferably not more than 120, more preferably not more than 100, and still more preferably not more than 80.

A Mooney viscosity is an index of industrial viscosity (JIS K 6300) measured by a Mooney viscometer, which is one type of rotational plasticizer, and ML1+4 (100° C.) is used as a unit symbol. M represents the Mooney viscosity, L represents a large rotor (L type), 1+4 represents a preheating time of 1 minute and a rotation time of the rotor is 4 minutes, and measurement is performed under conditions of 100° C.

As the polybutadiene, a polybutadiene synthesized using a rare earth element-based catalyst or a Group VIII metal compound catalyst may be used.

In the base rubber, a polybutadiene rubber synthesized with a catalyst different from a lanthanum-series rare earth element compound may be blended. Styrene-butadiene rubber (SBR), natural rubber, polyisoprene rubber, ethylene propylene diene rubber (EPDM), and the like may be blended, and one kind thereof may be used alone, or two or more kinds thereof may be used in combination.

A proportion of the polybutadiene in the whole rubber is preferably at least 60 wt %, more preferably at least 70 wt %, and most preferably at least 90 wt %. Further, 100 wt % of the base rubber, that is, all of the base rubber, may be the polybutadiene.

Next, the component (b) is a co-crosslinking agent, and is an α,β-unsaturated carboxylic acid and/or a metal salt thereof. The number of carbon atoms of the unsaturated carboxylic acid is preferably 3 to 8, and specific examples thereof include unsaturated carboxylic acids such as acrylic acid, methacrylic acid, maleic acid, and fumaric acid. Specific examples of a metal of the unsaturated carboxylic acid include zinc, sodium, magnesium, calcium, and aluminum, and zinc is particularly preferable. Therefore, zinc acrylate is most preferable as the co-crosslinking agent.

The compounding amount of the component (b) is preferably at least 10 parts by weight, more preferably at least 15 parts by weight, and still more preferably at least 20 parts by weight per 100 parts by weight of the base rubber of the component (a), and the upper limit is preferably not more than 65 parts by weight, more preferably not more than 60 parts by weight, and still more preferably not more than 55 parts by weight of the base rubber of the component (a). If the compounding amount is less than the above range, the resin composition becomes too soft and has poor rebound, and if the compounding amount is more than the above range, the resin composition becomes too hard and has a poor feel at impact, and is fragile and has inferior durability.

The co-crosslinking agent of the component (b) preferably has an average particle size of 3 to 30 μm, more preferably 5 to 25 μm, and still more preferably 8 to 15 μm. If the average particle size of the co-crosslinking agent is less than 3 μm, the co-crosslinking agent is easily aggregated in the rubber composition, a reactivity between acrylic acids is improved, and a reactivity between the base rubbers is reduced, so that a rebound performance of the golf ball may not be sufficiently obtained. If the average particle size of the co-crosslinking agent exceeds 30 μm, the co-crosslinking agent particles become too large, and variations in the characteristics of the resulting golf ball become large.

The component (c) is an organic peroxide, and as the organic peroxide, it is particularly preferable to use an organic peroxide having a 1-minute half-life temperature of 110 to 185° C. Examples of this kind of organic peroxide include a dicumyl peroxide (“Percumyl D” manufactured by NOF Corporation), a 2,5-dimethyl-2,5-di(t-butylperoxy) hexane (“Perhexa 25B” manufactured by NOF Corporation), and a di(2-t-butylperoxyisopropyl)benzene (“Perbutyl P” manufactured by NOF Corporation), and a dicumyl peroxide may be suitably used. Examples of other commercially available products include “Perhexa C-40”, “Nyper BW”, “Peroyl L” (all manufactured by NOF Corporation), and Luperco 231XL (manufactured by Atochem Company Limited). These may be used singly, or two or more may be used in combination.

The compounding amount of the component (c) is preferably at least 0.1 parts by weight, and more preferably at least 0.3 parts by weight per 100 parts by weight of the base rubber, and the upper limit thereof is preferably not more than 5 parts by weight, more preferably not more than 4 parts by weight, and still more preferably not more than 3 parts by weight per 100 parts by weight of the base rubber.

The component (d) is water or a moisture-providing agent. The water as the component (d) is not particularly limited, and may be distilled water or tap water, although it is particularly preferable to use distilled water containing no impurities.

If the component (d) is a moisture-providing agent, the moisture-providing agent is defined as a substance that contains a water component other than free water in its structure and desorbs moisture by heating, or a substance that releases a water component by thermal decomposition by heating. In general, examples of the type of water include free water, adsorbed water, interlayer water, zeolite water, and bound water. It is said that adsorbed water, interlayer water, and free water exist in clay minerals, and a clay mineral containing such interlayer water may be used as the component (d).

Examples of the clay mineral include layered double hydroxides such as hydrotalcite. That is, the layered double hydroxide (hereinafter also referred to as “LDH”) is a mineral having a multilayer structure, and water having a chemical bond exists between layers (interlayer water). For example, in the case of Mg—Al-based LDH, the interlayer water almost completely desorbs in a range of 180 to 300° C. In addition, in the case of Zn—Al-based LDH, the interlayer water desorbs at a lower temperature of 170 to 200° C.

In addition, a substance containing bound water is exemplified as the component (d). Specifically, it is a substance having water (coordination water) that forms a complex ion as a ligand, and examples thereof include hydrates of inorganic compounds. As the inorganic compound, for example, one or more selected from calcium sulfate 0.5-hydrate, calcium sulfate dihydrate, aluminum sulfate 14- to 18-hydrate, magnesium sulfate heptahydrate, beryllium sulfate tetrahydrate, zirconium sulfate tetrahydrate, manganese sulfate pentahydrate, iron sulfate heptahydrate, cobalt sulfate heptahydrate, nickel sulfate hexahydrate, cupric sulfate pentahydrate, zinc sulfate heptahydrate, cadmium sulfate octahydrate, indium sulfate nonahydrate, zinc sulfate dihydrate, and the like may be used in combination.

Further, examples of the component (d) include a substance that releases a water component by thermal decomposition by heating. Examples thereof include a substance that exists as a hydroxide ion in the substance but escapes as water (H₂O) when heated, examples of which include aluminum hydroxide and magnesium hydroxide.

Regarding the moisture-providing agent, it is preferable that a moisture dissociation ratio is at least 60% in weight ratio if the rubber composition is heated to a temperature at which the rubber composition is vulcanized or if the temperature inside the core reaches the maximum temperature due to self-reaction heat during vulcanization. In addition, from the viewpoint of enhancing the supply efficiency of moisture, it is preferable to use a moisture-providing agent having a high moisture content by weight ratio.

Specifically, for example, a content ratio of moisture in a molecular formula of the moisture-providing agent is preferably at least 6%, and more preferably at least 15% in weight ratio. The content ratio of moisture in the molecular formula of the moisture-providing agent is preferably high, and the upper limit is not particularly limited, although the upper limit may be, for example, not more than 90% in terms of weight ratio from the viewpoint of availability and the like.

As the moisture-providing agent, it is preferable that moisture may be released as much as possible when the rubber composition is vulcanized. However, vulcanization conditions such as a vulcanization temperature and a vulcanization time may change depending on components contained in the rubber composition such as the base rubber and the organic peroxide. Therefore, it is preferable to select a moisture-providing agent capable of releasing a desired amount of moisture under vulcanization conditions such as the vulcanization temperature, according to the vulcanization conditions of the rubber composition to which the moisture-providing agent is added.

In addition, since the moisture dissociation ratio of the moisture-providing agent when the rubber composition is kneaded is preferably low, for example, the moisture dissociation ratio when the rubber composition is heated to 90° C., that is, the cumulative moisture dissociation ratio when the rubber composition is heated to 90° C., is preferably not more than 60% in terms of the weight ratio.

The compounding amount of the component (d) is preferably at least 0.1 parts by weight, more preferably at least 0.3 parts by weight, and still more preferably at least 0.5 parts by weight per 100 parts by weight of the base rubber, and the upper limit thereof is preferably not more than 15 parts by weight, more preferably not more than 10 parts by weight, still more preferably not more than 5 parts by weight, and still more preferably not more than 3 parts by weight per 100 parts by weight of the base rubber. If the compounding amount of the component (d) is too large, the hardness is softened, and the desired feel at impact, durability, and rebound may not be obtained. If the compounding amount is too small, a desired core hardness profile may not be obtained, and it may be impossible to sufficiently realize low ball spin when the ball is struck.

The component (e) is a hindered phenol-based antioxidant having a substituent having a thioether structure. The hindered phenol-based antioxidant preferably has a chemical structure having at least one methyl group at an ortho position. In the hindered phenol-based antioxidant, the number of substituents having a thioether structure is preferably at least two.

By blending the component (e) into the rubber composition, normal striking durability performance may be improved, and even if foreign matter is mixed into the rubber material, a decrease in striking durability may be maintained at not less than a certain level.

Specifically, the hindered phenol-based antioxidant, which is the component (e), is preferably represented by the following general formula (I).

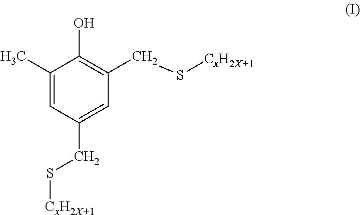

In the above formula, x is an integer of not less than 1, and x is preferably an integer of not less than 8.

Specifically, trade names “ANTAGE HP-500” and “ANTAGE HP-400” (all manufactured by Kawaguchi Chemical Industry Co., Ltd.) and a trade name “Irganox 1520 L” manufactured by BASF may be used as the component (e).

The compounding amount of the component (e) is at least 0.2 parts by weight, preferably at least 0.3 parts by weight, and more preferably at least 0.5 parts by weight per 100 parts by weight of the base rubber. The upper limit is preferably not more than 3.0 parts by weight, more preferably not more than 2.0 parts by weight, and still more preferably not more than 1.5 parts by weight per 100 parts by weight of the base rubber. If the compounding amount of the component (e) is too large, the hardness is softened, and the desired feel at impact, durability, and rebound may not be obtained, and if the compounding amount is too small, an effect of desired striking durability may not be obtained.

The component (e) may be added to the component (a) at the time of producing the rubber composition, or may be added in advance at the time of producing the component (a), or these addition methods may be used in combination.

In addition to the components (a) to (e) described above, for example, various additives such as a component (f), a component (g), a component (h), a filler, and a processing aid described below may be blended as long as the effects of the present invention are not hindered.

The component (f) is a benzimidazole represented by the following general formula (II) and/or a metal salt thereof, and is used as an antioxidant.

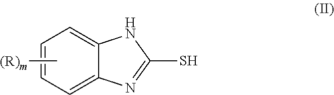

R in the formula (II) is a hydrogen atom or a hydrocarbon group having 1 to 20 carbon atoms, m is an integer of 1 to 4, and if m is not less than 2, R and m may be the same as or different from each other. Specific examples of the benzimidazole having the formula (II) include 2-mercaptobenzimidazole, 2-mercaptomethylbenzimidazole, and metal salts thereof, and the metal salt is preferably a zinc salt.

The compounding amount of the benzimidazole represented by the above specific formula and/or the metal salt thereof as the component (f) is preferably at least 0.1 parts by weight, and more preferably at least 0.3 parts by weight per 100 parts by weight of the base rubber, and the upper limit thereof is preferably not more than 5 parts by weight, and more preferably not more than 3 parts by weight per 100 parts by weight of the base rubber. If the compounding amount of the component (f) is too small, a crosslinking reaction in a vicinity of the core surface is not efficiently promoted, a crosslinking density is not sufficiently increased, a hard layer having hardness is not sufficiently formed, a hardness difference between the core surface and the core center as an entire core is not sufficiently increased, and sufficient striking durability performance may not be obtained. On the other hand, even if the compounding amount of the component (f) is unnecessarily increased, the obtained effect does not change to the above suitable addition amount or more.

The component (g) is sulfur or an alkylphenol disulfide polymer having the following chemical structure.

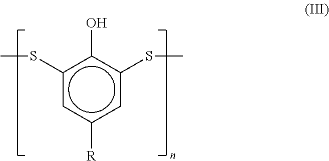

In the formula (III), R represents an alkyl group, and n represents a polymerization degree in a range of 2 to 20. The alkyl group of R is preferably a lower alkyl group having 1 to 6 carbon atoms, and specific examples thereof include those selected from a group of a methyl group, an ethyl group, a n-propyl group, an iso-propyl group, a n-butyl group, a tert-butyl group, a n-amyl group (pentyl group), an iso-amyl group (pentyl group), a tert-amyl group (pentyl group), a sec-isoamyl group, a neopentyl group, a n-hexyl group, an iso-hexyl group, and a tert-hexyl group. More preferably, the organosulfur compound as a component (g-1) is an amylphenol disulfide polymer, and specifically, commercially available products such as “Sanceler AP” (manufactured by Sanshin Chemical Industry Co., Ltd.) and “Vultac 5” (manufactured by Arkema Japan) may be used.

The compounding amount of the component (g) that is an alkylphenol disulfide polymer is not particularly limited, although the compounding amount is preferably at least 0.05 parts by weight, more preferably at least 0.1 parts by weight, and most preferably at least 0.3 parts by weight per 100 parts by weight of the rubber component. The upper limit is preferably not more than 5.0 parts by weight, more preferably not more than 3.0 parts by weight, and most preferably not more than 2.0 parts by weight. If the compounding amount is too large, the crosslinking reaction by the organic peroxide is inhibited by the influence of sulfur, and an entire hardness of a molded product tends to be greatly softened.

On the other hand, if the component (g) is a sulfur, commercially available products may be used as the sulfur, and for example, “SULFAX 5” manufactured by Tsurumi Chemical Industry Co., Ltd., “SANMIX S-80N” and “SANMIX IS-60N” manufactured by Sanshin Chemical Industry Co., Ltd., and “Akroform S-80/EPR/P” manufactured by Akrochem may be used.

The compounding amount of the sulfur is not particularly limited, although the compounding amount is preferably at least 0.01 parts by weight, more preferably at least 0.03 parts by weight, and most preferably at least 0.05 parts by weight per 100 parts by weight of the rubber component. The upper limit is preferably not more than 5.0 parts by weight, more preferably not more than 2.0 parts by weight, and most preferably not more than 1.0 part by weight of the rubber component. If the compounding amount is too large, the crosslinking reaction by the organic peroxide is inhibited by the influence of sulfur, and an entire hardness of a molded product tends to be greatly softened. On the other hand, if the compounding amount is too small, the hardness difference between the surface and the center may not be able to be increased in a core internal hardness.

Sulfur is desirably used in the form of a masterbatch in order to enhance dispersibility of a minute amount of sulfur. Examples of such a sulfur masterbatch may include the above-mentioned trade names “SANMIX S-80N”, “SANMIX IS-60N”, and “Akroform S-80/EPR/P”.

As a filler, for example, zinc oxide, barium sulfate, calcium carbonate, or the like may be suitably used. These may be used singly, or two or more may be used in combination. The compounding amount of the filler may be preferably at least 1 part by weight, more preferably at least 3 parts by weight, and even more preferably at least 5 parts by weight per 100 parts by weight of the base rubber. In addition, an upper limit of the compounding amount may be preferably not more than 100 parts by weight, more preferably not more than 60 parts by weight, and even more preferably not more than 40 parts by weight per 100 parts by weight of the base rubber. If the compounding amount is too large or too small, it may not be possible to obtain an appropriate weight and a suitable rebound.

The component (h) is an organosulfur compound different from the component (g). The organosulfur compound is not particularly limited, and examples thereof may include thiophenols, thionaphthols, diphenyl polysulfides, halogenated thiophenols, and metal salts thereof. Specific examples thereof may include zinc salts of pentachlorothiophenol, pentafluorothiophenol, pentabromothiophenol, parachlorothiophenol, and the like, diphenyl polysulfide having 2 to 4 sulfur atoms, dibenzyl polysulfide, dibenzoyl polysulfide, dibenzothiazoyl polysulfide, dithiobenzoyl polysulfide, and 2-thionaphthol. These may be used singly, or two or more may be used in combination. Among them, a zinc salt of pentachlorothiophenol and/or diphenyl disulfide may be suitably used.

The compounding amount of the organosulfur compound is preferably at least 0.05 parts by weight, more preferably at least 0.1 parts by weight, and even more preferably at least 0.2 parts by weight, and the upper limit is preferably not more than 3 parts by weight, more preferably not more than 2 parts by weight, and even more preferably not more than 1 part by weight per 100 parts by weight of the base rubber. If the compounding amount of the organosulfur compound is too large, the hardness of the heat-molded product of the rubber composition may become too soft, whereas if the compounding amount is too small, the rebound may not be expected to be improved.

As the processing aid, a higher fatty acid, a metal salt thereof, or the like may be suitably used. Examples of the higher fatty acid include stearic acid, palmitic acid, oleic acid, linoleic acid, linolenic acid, and myristic acid, and stearic acid is particularly preferable. Examples of the metal salt of the higher fatty acid include a lithium salt, a sodium salt, a potassium salt, a copper salt, a magnesium salt, a calcium salt, a strontium salt, a barium salt, a tin salt, a cobalt salt, a nickel salt, a zinc salt, and an aluminum salt, and in particular, zinc stearate is suitably used. The compounding amount of the processing aid may be preferably at least 1 part by weight, more preferably at least 3 parts by weight, and still more preferably at least 5 parts by weight per 100 parts by weight of the base rubber. In addition, an upper limit of the compounding amount is preferably not more than 20 parts by weight, more preferably not more than 15 parts by weight, and still more preferably not more than 10 parts by weight per 100 parts by weight of the base rubber. If the compounding amount is too large, sufficient hardness and rebound may not be obtained, and if the compounding amount is too small, an additive chemical is not sufficiently dispersed, and expected physical properties may not be obtained. Although not particularly limited, examples of the method for adding the processing aid include a method in which the processing aid is put into a mixer simultaneously with other chemicals, a method in which the processing aid is added in advance by mixing with other chemicals such as the component (b) in advance, a method in which the processing aid is added by coating surfaces of other chemicals such as the component (b), and a method in which a masterbatch is prepared in advance together with the component (a) and added.

The rubber composition may contain an antioxidant different from the component (c). Specific examples thereof include hindered phenol-based antioxidants such as 2,6-di-tert-butyl-4-methylphenol, 2,6-di-tert-butyl-4-ethylphenol, pentaerythritol tetrakis [3-(3,5-di-tert-butyl-4-hydroxyphenyl) propionate], 1,3,5-tris(3′,5′-di-t-butyl-4-hydroxybenzyl) isocyanuric acid, 2,2′-methylenebis(4-methyl-6-tert-butylphenol), 4,4′,4″-(1-methylpropanyl-3-ylidene)tris(6-tert-butyl-m-cresol), and the like. Commercially available products that may be used include Nocrac 200, Nocrac M-17, Nocrac NS-6 (manufactured by Ouchi Shinko Chemical Industrial Co., Ltd.), IRGANOX 1010 (manufactured by BASF), ADK STAB AO-20, ADK STAB AO-30 (manufactured by ADEKA Corporation), and the like. These may be used singly, or two or more may be used in combination. The compounding amount of the antioxidant is not particularly limited, although the compounding amount is preferably not more than 1.0 part by weight, more preferably not more than 0.7 parts by weight, and still more preferably not more than 0.5 parts by weight per 100 parts by weight of the base rubber. If the compounding amount is too large, an effect of improving the durability by the component (c) may not be obtained.

A core that is a vulcanized molded product may be manufactured by vulcanizing and hardening the rubber composition. For example, the core, which is the vulcanized molded product, may be manufactured by intensively mixing the rubber composition using a mixing apparatus such as a Banbury mixer or a roll mill, subsequently compression molding or injection molding the mixture using a core mold, and curing the resulting molded body by appropriately heating it at a temperature sufficient for the organic peroxide or the co-crosslinking agent to act, such as at a temperature of approximately 100 to 200° C., and for 10 to 40 minutes.

Next, the cover is described.

The cover has a material hardness on the Shore D hardness scale which, although not particularly limited, is preferably at least 35, more preferably at least 40, and still more preferably at least 43, and the upper limit is preferably not more than 53, more preferably not more than 50, and still more preferably not more than 47. In addition, expressed on the Shore D hardness scale, a surface hardness of a sphere (ball surface hardness) is preferably at least 54, more preferably at least 56, and still more preferably at least 58, and the upper limit thereof is preferably not more than 64, more preferably not more than 62, and still more preferably not more than 60. If the material hardness of the cover and the surface hardness of the ball are too soft in comparison with the above ranges, the spin rate on full shots may rise excessively, and the distance may not be increased. On the other hand, if the material hardness and the surface hardness are too hard, a scuff resistance may worsen, or the spin rate in the short game may be insufficient.

The cover has a material hardness on the Shore C hardness scale that is preferably at least 57, more preferably at least 63, and still more preferably at least 67, and the upper limit thereof is preferably not more than 80, more preferably not more than 76, and still more preferably not more than 72. The ball has a surface hardness on the Shore C hardness scale that is preferably at least 77, more preferably at least 80, and still more preferably at least 85, and the upper limit thereof is preferably not more than 93, more preferably not more than 91, and still more preferably not more than 89.

The cover has a thickness of preferably at least 0.3 mm, more preferably at least 0.45 mm, and even more preferably at least 0.6 mm. On the other hand, the upper limit of the cover thickness is preferably not more than 1.2 mm, more preferably not more than 1.15 mm, and even more preferably not more than 1.0 mm. If the cover is too thick, the rebound may be insufficient or the spin may be increased on full shots with an iron, and a desired distance may not be increased. On the other hand, if the cover is too thin, the scuff resistance may worsen or the ball may not be sufficiently receptive to spin on approach shots and may thus lack sufficient controllability.

As a material of the cover, various thermoplastic resins used in a cover material of a golf ball may be used, although a soft material is required in order to obtain excellent spin performance that can satisfy professionals and advanced players, and in order to achieve both excellent scuff resistance and rebound, it is preferable to use a resin material mainly composed of thermoplastic polyurethane. That is, the cover is suitably formed of a resin blend containing (I) a thermoplastic polyurethane and (II) a polyisocyanate compound as principal components.

The total weight of the components (I) and (II) is recommended to be at least 60%, and more preferably at least 70% with respect to a total amount of the resin composition of the cover. The components (I) and (II) are described in detail below.

Describing the thermoplastic polyurethane (I), the structure of the thermoplastic polyurethane includes a soft segment composed of a polymeric polyol (polymeric glycol), which is a long-chain polyol, and a hard segment composed of a chain extender and a polyisocyanate compound. Here, as the long-chain polyol serving as a starting material, any of those hitherto used in the art related to thermoplastic polyurethane may be used, and are not particularly limited, and examples thereof may include polyester polyol, polyether polyol, polycarbonate polyol, polyester polycarbonate polyol, polyolefin polyol, conjugated diene polymer-based polyol, castor oil-based polyol, silicone-based polyol, and vinyl polymer-based polyol. These long-chain polyols may be used singly, or two or more may be used in combination. Among them, a polyether polyol is preferable from the viewpoint that a thermoplastic polyurethane having a high rebound resilience and excellent low-temperature properties may be synthesized.

As the chain extender, those hitherto used in the art related to thermoplastic polyurethanes may be suitably used, and for example, a low-molecular-weight compound having on the molecule two or more active hydrogen atoms capable of reacting with an isocyanate group and having a molecular weight of not more than 400 is preferable. Although not limited, examples of the chain extender include 1,4-butylene glycol, 1,2-ethylene glycol, 1,3-butanediol, 1,6-hexanediol, 2,2-dimethyl-1,3-propanediol, or the like. Among them, the chain extender is preferably an aliphatic diol having from 2 to 12 carbon atoms, and is more preferably 1,4-butylene glycol.

As the polyisocyanate compound, those hitherto used in the art related to thermoplastic polyurethane may be suitably used, and are not particularly limited. Specifically, one or more selected from a group consisting of 4,4′-diphenylmethane diisocyanate, 2,4-toluene diisocyanate (or) 2,6-toluene diisocyanate, p-phenylene diisocyanate, xylylene diisocyanate, 1,5-naphthylene diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate, and dimer acid diisocyanate may be used. However, it may be difficult to control a crosslinking reaction during injection molding depending on the type of isocyanate. In the present invention, 4,4′-diphenylmethane diisocyanate, which is an aromatic diisocyanate, is most preferable from the viewpoint of providing a balance between stability during production and physical properties to be manifested.

As specific examples of the thermoplastic polyurethane serving as the component (I), commercially available products may be used such as Pandex T-8295, Pandex T-8290, and Pandex T-8260 (all manufactured by DIC Covestro Polymer Ltd.).

Although not an essential component, a thermoplastic elastomer other than the thermoplastic polyurethane may be included as a separate component (III) with the components (I) and (II). By including the component (III) in the resin blend, a flowability of the resin blend may be further improved, and various physical properties required of the golf ball cover material may be increased, such as rebound and scuff resistance.

A compositional ratio of the components (I), (II), and (III) is not particularly limited, although in order to sufficiently and effectively exhibit the advantageous effects of the present invention, the compositional ratio (I):(II):(III) is preferably in a weight ratio range of from 100:2:50 to 100:50:0, and still more preferably from 100:2:50 to 100:30:8.

Furthermore, various additives other than the components constituting the thermoplastic polyurethane may be included in the resin blend as necessary, and for example, a pigment, a dispersant, an antioxidant, a light stabilizer, an ultraviolet absorber, an internal mold lubricant, or the like may be appropriately included.

An intermediate layer may be interposed between the core and the cover. The intermediate layer is preferably formed of a resin material, as described later.

The intermediate layer has a material hardness on the Shore D hardness scale which, although not particularly limited, is preferably at least 62, more preferably at least 64, and even more preferably at least 66, and the upper limit is preferably not more than 72, more preferably not more than 70, and even more preferably not more than 68. A sphere obtained by encasing the core with the intermediate layer (intermediate layer-encased sphere) has a surface hardness which, on the Shore D hardness scale, is preferably at least 68, more preferably at least 70, and even more preferably at least 72. The upper limit is preferably not more than 78, more preferably not more than 76, and even more preferably not more than 74. If the material hardness and the surface hardness of these intermediate layers are too soft in comparison with the above ranges, the spin rate on full shots may be excessively increased and the distance may not be increased, or an initial velocity as a ball may be lowered, and the distance may not be increased on full shots. On the other hand, if the material hardness and the surface hardness are too hard, the durability to cracking on repeated impact may worsen, or the spin rate in the short game may be too low.

The intermediate layer has a material hardness on the Shore C hardness scale which is preferably at least 92, more preferably at least 94, and even more preferably at least 95, and the upper limit is preferably not more than 100, more preferably not more than 98, and even more preferably not more than 96. The intermediate layer-encased sphere has a surface hardness which, on the Shore C hardness scale, is preferably at least 93, more preferably at least 95, and even more preferably at least 97. The upper limit is preferably not more than 100, more preferably not more than 99, and even more preferably not more than 98.

The intermediate layer has a thickness which is preferably at least 1.00 mm, more preferably at least 1.10 mm, and even more preferably at least 1.15 mm. The intermediate layer thickness has an upper limit that is preferably not more than 1.45 mm, more preferably not more than 1.35 mm, and even more preferably not more than 1.25 mm. A value of intermediate layer thickness (mm)/ball diameter (mm) is preferably at least 0.023, more preferably at least 0.026, and still more preferably at least 0.027, and the upper limit thereof is preferably not more than 0.034, more preferably not more than 0.032, and still more preferably not more than 0.029. If the above value is too small, it may not be possible to achieve both a moderate hardness and a crisp feel for the feel at impact on full shots, so that professionals and advanced players may not be given a good feel at impact, or the durability to cracking on repeated impact may worsen. On the other hand, if the above value is too large, the crisp feel may be weakened, and professionals or advanced players may not be given a good feel at impact.

A value obtained by subtracting the cover thickness from the intermediate layer thickness is preferably greater than 0, more preferably at least 0.20 mm, and still more preferably at least 0.32 mm, and the upper limit is preferably not more than 0.62 mm, more preferably not more than 0.58 mm, and still more preferably not more than 0.55 mm. If this value falls outside of the above ranges, the spin rate of the ball on full shots may rise, an actual initial velocity may become low, and a target distance may be unattainable. On the other hand, if this value is too small, the durability to cracking on repeated impact may worsen.

As a material of the intermediate layer, various thermoplastic resins used as a golf ball material, and particularly a resin material with an ionomer resin as a chief material, may be used.

The ionomer resin material preferably contains an ionomer having a high acid content. For example, a high-acid ionomer resin having an acid content of at least 16 wt % among commercially available ionomer resins is blended with an ordinary ionomer resin and used. With this blending, it is possible to secure a target distance by achieving both low spin and high rebound on full shots with a driver (W #1).

The content (acid content) of the unsaturated carboxylic acid contained in the high-acid ionomer resin is usually at least 16 wt %, preferably at least 17 wt %, and more preferably at least 18 wt %, and the upper limit thereof is preferably not more than 22 wt %, more preferably not more than 21 wt %, and still more preferably not more than 20 wt %. If this value is too small, spin increases on full shots with a driver (W #1), a utility club, or an iron, and a target distance may not be obtained. On the other hand, if the above value is too large, the feel at impact may be too hard, or the durability to cracking on repeated impact may worsen.

In addition, the high-acid ionomer resin is preferably at least 20 wt %, more preferably at least 50 wt %, and still more preferably at least 60 wt % per 100 wt % of the resin material, and the upper limit is not more than 100 wt %, preferably not more than 90 wt %, and more preferably not more than 85 wt % per 100 wt % of the resin material. If the compounding amount of the high-acid ionomer resin is too small, the spin rate of the ball on full shots may increase and the distance may not be increased. On the other hand, if the compounding amount of the high-acid ionomer resin is too large, the durability on repeated impact may worsen.

In addition, if an ionomer resin is used as the base resin, an aspect that uses in admixture a zinc-neutralized ionomer resin and a sodium-neutralized ionomer resin as the base resins is desirable. The blending ratio in terms of zinc-neutralized ionomer resin/sodium-neutralized ionomer resin (weight ratio) is from 5/95 to 95/5, preferably from 10/90 to 90/10, and still more preferably from 15/85 to 85/15. If the zinc-neutralized ionomer and the sodium-neutralized ionomer are not included in this ratio, the rebound may become too low to obtain a desired flight, the durability to cracking on repeated impact at room temperature may worsen, and the durability to cracking at a low temperature (below zero) may worsen.

An inorganic particulate filler may be blended in the intermediate layer material. The inorganic particulate filler is a component that adjusts a specific gravity and is blended as a reinforcing agent, and is not particularly limited, although zinc oxide, barium sulfate, titanium dioxide, and the like may be appropriately used. In addition, barium sulfate is preferable, and precipitated barium sulfate is still more preferable, since an effect of improving the durability to cracking on repeated impact is large.

A mean particle size of the inorganic particulate filler is not particularly limited, although the mean particle size may be preferably 0.01 to 10 0 μm, and more preferably 0.1 to 10 μm.

Regardless of whether the mean particle size of the inorganic particulate filler is too small or too large, dispersibility during material preparation may worsen.

The above mean particle size means a particle size measured by a particle size distribution measuring apparatus after being dispersed in an aqueous solution together with an appropriate dispersant.

The compounding amount of the inorganic particulate filler is usually more than 0 parts by weight, preferably at least 10 parts by weight, and more preferably at least 15 parts by weight per 100 parts by weight of the base resin of the intermediate layer material, and the upper limit thereof is usually not more than 50 parts by weight, preferably not more than 40 parts by weight, and more preferably not more than 30 parts by weight per 100 parts by weight of the base resin of the intermediate layer material. If this compounding amount is too small, the durability to cracking on repeated impact may worsen. On the other hand, if the compounding amount is too large, the rebound of the ball may be lowered, the spin rate on full shots may be increased, and a target distance may not be increased.

In the intermediate layer material, an optional additive may be appropriately included depending on the intended use. For example, various additives such as a pigment, a dispersant, an antioxidant, an ultraviolet absorber, and a light stabilizer may be included. If these additives are included, the compounding amount thereof is preferably at least 0.1 parts by weight, and more preferably at least 0.5 parts by weight, and an upper limit thereof is preferably not more than 10 parts by weight, and more preferably not more than 4 parts by weight per 100 parts by weight of the base resin.

For the intermediate layer material, it is suitable to abrade a surface of the intermediate layer in order to increase a degree of adhesion to a polyurethane suitably used in a cover material described later. Further, it is preferable that a primer (adhesive agent) is applied to the surface of the intermediate layer after the abrasion treatment, or an adhesion reinforcing agent is added to the intermediate layer material.

The intermediate layer material has a specific gravity which, although not particularly limited, is preferably at least 0.94, more preferably at least 1.06, and even more preferably at least 1.08. The upper limit is preferably not more than 1.25, more preferably not more than 1.20, and even more preferably not more than 1.15. If the specific gravity of the intermediate layer is too small, the durability to cracking on repeated impact may worsen. On the other hand, if the specific gravity of the intermediate layer is too large, the ball rebound may become low, the spin rate on full shots may rise, and a target distance may not be increased.

The manufacture of a golf ball in which the above-described core, intermediate layer, and cover (outermost layer) are formed as successive layers may be performed by a customary method such as a known injection molding process. For example, an intermediate layer material is injected around the core in an injection mold to obtain each layer-encased sphere, and then the cover material, which is the outermost layer, is injection molded to obtain the golf ball. In addition, as each encasing layer, it is also possible to produce the golf ball by preparing two half-cups pre-molded into hemispherical shapes, enclosing the layer-encased sphere within the two half-cups, and molding the encased spheres under applied heat and pressure.

A deflection (mm) when the golf ball is compressed under a final load of 1,275 N (130 kgf) from an initial load of 98 N (10 kgf) is preferably at least 2.0 mm, more preferably at least 2.2 mm, and still more preferably at least 2.4 mm, and an upper limit thereof is preferably not more than 3.1 mm, more preferably not more than 2.9 mm, and still more preferably not more than 2.7 mm. If the deflection of the golf ball is too small, that is, if the golf ball is too hard, the spin rate of the ball may rise excessively and a good distance may not be achieved, and the feel at impact may become too hard. On the other hand, if the deflection is too large, that is, if the sphere is too soft, the durability to cracking on repeated impact may worsen, the actual initial velocity may be lowered, and the distance on shots with a driver (W #1) may not be increased.

### [Relationship Between Deflection of Core and Ball]

Letting the deflection when the core is compressed under a final load of 1,275 N (130 kgf) from an initial load of 98 N (10 kgf) be A (mm), and the deflection when the golf ball is compressed under a final load of 1,275 N (130 kgf) from an initial load of 98 N (10 kgf) be B (mm), a value of A-B is preferably at least 0.55 mm, more preferably at least 0.60 mm, and still more preferably at least 0.65 mm, and an upper limit thereof is preferably less than 1.0 mm, more preferably not more than 0.95 mm, and still more preferably not more than 0.90 mm. If this value is too large, the actual initial velocity of the ball on shots with a driver (W #1) may become low, a target distance may not be attainable, professionals and advanced players with a high head speed may not be given a good feel at impact, and the durability to cracking on repeated impact may worsen. On the other hand, if this value is too small, there may be a poor feel at impact, and the durability to cracking on repeated impact may worsen.

A ratio of the deflection of the core to the deflection of the ball, that is, a value of A/B, is preferably at least 1.15, more preferably at least 1.20, and still more preferably at least 1.25, and the upper limit thereof is preferably not more than 1.40, more preferably not more than 1.35, and still more preferably not more than 1.32. If this value is too large, the actual initial velocity of the ball on shots with a driver (W #1) may become low, a target distance may not be attainable, professionals and advanced players with a high head speed may not be given a good feel at impact, and the durability to cracking on repeated impact may worsen. On the other hand, if this value is too small, there may be a poor feel at impact, and the durability to cracking on repeated impact may worsen.

### [Core Diameter and Ball Diameter]

A relationship between the core diameter and the ball diameter, that is, a value of (core diameter)/(ball diameter), is preferably at least 0.867, more preferably at least 0.890, and even more preferably at least 0.897. On the other hand, an upper limit thereof is preferably not more than 0.930, more preferably not more than 0.920, and even more preferably not more than 0.913. If this value is too small, the deflection of an entire ball becomes small and the ball becomes hard, the spin rate of the ball on full shots may rise, and a target distance may not be attainable. On the other hand, if the above value is too large, the spin rate of the ball on full shots may rise, and a target distance may not be attainable.

### [Hardness Relationship of Layers]

The intermediate layer-encased sphere is preferably higher in surface hardness than the ball. Expressed on the Shore C hardness scale, a difference between these surface hardnesses (surface hardness of intermediate layer-encased sphere-ball surface hardness) is preferably at least 1, more preferably at least 3, and even more preferably at least 5, and an upper limit thereof is preferably not more than 15, more preferably not more than 12, and even more preferably not more than 10. Expressed on the Shore D hardness scale, the difference is preferably at least 1, more preferably at least 3, and even more preferably at least 5, and the upper limit thereof is preferably not more than 16, more preferably not more than 14, and even more preferably not more than 12. If the above value is small, the spin rate on approach shots is reduced, and spin controllability in the short game may worsen. On the other hand, if the above value is large, and the large value is caused by the material hardness of the intermediate layer, the durability to cracking on repeated impact may worsen. If the large value is caused by the material hardness of the cover, the spin rate increases on full shots, and a target distance may not be obtained.

The intermediate layer-encased sphere is preferably higher in surface hardness than the core. Expressed on the Shore C hardness scale, a difference between these surface hardnesses (surface hardness of intermediate layer-encased sphere-core surface hardness) is preferably at least 1, more preferably at least 6, and even more preferably at least 10, and an upper limit thereof is preferably not more than 25, more preferably not more than 20, and even more preferably not more than 15. If the above value is too small, the spin rate rises on full shots, and a target distance may not be attainable. On the other hand, if the above value is too large, the durability to cracking on repeated impact may worsen, the actual initial velocity of the ball becomes lower, and a target distance may not be attainable.

Expressed on the Shore C hardness scale, a value obtained by subtracting the core center hardness from the surface hardness of the intermediate layer-encased sphere is preferably at least 23, more preferably at least 25, and even more preferably at least 28, and an upper limit thereof is preferably not more than 47, more preferably not more than 42, and even more preferably not more than 35. If the above value is too small, the spin rate rises on full shots, and a target distance may not be attainable. On the other hand, if the above value is too large, the durability to cracking on repeated impact may worsen, the actual initial velocity on shots with a driver (W #1) may be lowered, and a target distance may not be obtained.

### [Specific Gravities of Layers]

It is recommended that a difference in the specific gravity of each layer between the specific gravity of the core, the specific gravity of the intermediate layer, and the specific gravity of the cover is typically within +0.15, preferably within +0.10, and more preferably within +0.05. That is, a value of (specific gravity of core)−(specific gravity of intermediate layer material), a value of (specific gravity of cover)−(specific gravity of intermediate layer material), and a value of (specific gravity of core)−(specific gravity of cover material) is typically at least-0.15, preferably at least-0.10, and more preferably at least-0.05, and the upper limit is typically not more than 0.15, preferably not more than 0.10, and more preferably not more than 0.05. If the difference in specific gravity between the layers is too large, in a case where the intermediate layer material and/or the cover material cannot be molded completely concentrically with the layers located inside these layers and is eccentric, when the ball is struck with a putter, the ball may greatly wobble to the left or right.

Numerous dimples may be formed on the outside surface of the cover. Although not particularly limited, the number of dimples arranged on the surface of the cover may be preferably at least 250, more preferably at least 300, and even more preferably at least 320, and an upper limit thereof may be preferably not more than 380, more preferably not more than 350, and even more preferably not more than 340. If the number of dimples is larger than the above range, a ball trajectory may become lower, and a distance traveled by the ball may decrease. On the other hand, if the number of dimples decreases, the ball trajectory may become higher, and the distance traveled by the ball may not increase.

As for the shape of the dimples, one type or a combination of two or more types such as a circular shape, various polygonal shapes, a dewdrop shape, and other oval shapes may be appropriately used. For example, if circular dimples are used, the diameter may be about 2.5 mm or more and 6.5 mm or less, and the depth may be at least 0.08 mm and not more than 0.30 mm.

A dimple coverage ratio of the dimples on the spherical surface of the golf ball, specifically, a ratio (SR value) of a sum of the individual dimple surface areas, each defined by a flat plane circumscribed by an edge of a dimple, to a ball spherical surface area on the assumption that the ball has no dimples is desirably at least 70% and not more than 90% from the viewpoint of sufficiently exhibiting aerodynamic properties. In addition, a value V₀ obtained by dividing a spatial volume of the dimples below the flat plane circumscribed by the edge of each dimple by a volume of a cylinder whose base is the flat plane and whose height is a maximum depth of the dimple from the base is preferably at least 0.35 and not more than 0.80 from the viewpoint of optimizing the ball trajectory. Furthermore, a VR value of a sum of the volumes of the individual dimples formed below the flat plane circumscribed by the edge of the dimple to a ball spherical volume on the assumption that the ball has no dimples is preferably at least 0.6% and not more than 0.8%. If there is a deviation from the ranges of each numerical value described above, the resulting trajectory may not enable a good distance to be attained, and the ball may fail to travel a sufficiently satisfactory distance.

The golf ball of the present invention may be made to conform to the Rules of Golf for play. The inventive ball may be formed to a diameter which is such that the ball does not pass through a ring having an inner diameter of 42.672 mm and to a weight which is preferably between 45.0 and 45.93 g.

### EXAMPLES

Hereinafter, the present invention is specifically described with reference to Examples and Comparative Examples, but the present invention is not limited to the following Examples.

### Examples 1 to 3 and Comparative Examples 1 to 9

### [Formation of Core]

Rubber compositions of Examples 1 and 2 and Comparative Examples 1 to 4 shown in Table 1 were prepared, and then vulcanization molding was performed at temperatures and for times shown in Table 1 to produce solid cores.

In Example 3 and Comparative Examples 5 to 9, solid cores are produced from rubber compositions and in vulcanization conditions shown in Table 1 in the same manner as described above.

TABLE 1

| | Example | | | Comparative Example | | | | | | | | |
|---|---|---|---|---|---|---|---|---|---|---|---|---|
| | 1 | 2 | 3 | 1 | 2 | 3 | 4 | 5 | 6 | 7 | 8 | 9 |
| Polybutadiene A | 100 | 100 | 100 | 100 | 100 | 100 | 100 | 100 | 100 | | 80 | 80 |
| Polybutadiene B | | | | | | | | | | 100 | 20 | 20 |
| Zinc acrylate A | | | | | | | | 30.5 | 28.5 | | | |
| Zinc acrylate B | 37.8 | 34.9 | 37.8 | 35.0 | 32.9 | 31.3 | 28.5 | | | 33.3 | 40.0 | 37.2 |
| Zinc stearate | | | | 2.0 | 2.0 | 2.0 | 2.0 | 2.0 | 2.0 | | | |
| Organic peroxide A | 1.0 | 1.0 | 1.0 | 1.0 | 1.0 | 1.0 | 1.0 | 0.6 | 0.6 | 1.0 | 1.0 | 1.0 |
| Organic peroxide B | | | | | | | | 0.6 | 0.6 | | | |
| Sulfur | | | | 0.025 | 0.025 | 0.013 | 0.013 | | | | | |
| Water | 0.5 | 0.5 | 0.5 | 0.3 | 0.3 | 0.2 | 0.2 | | | 0.4 | 1.2 | 1.2 |
| Antioxidant A | | | | 0.1 | 0.1 | | | 0.2 | 0.2 | 0.1 | 0.1 | 0.1 |
| Antioxidant B | 0.3 | 0.3 | 0.3 | | | 0.3 | 0.3 | | | | | |
| Antioxidant C | 0.5 | 0.5 | 0.5 | | | | | | | | | |
| Zinc oxide | 12.6 | 13.2 | 12.6 | 11.9 | 13.0 | 13.5 | 15.0 | 4.0 | 4.0 | 17.2 | 4.0 | 4.0 |
| Barium sulfate | | | | | | | | 15.8 | 16.6 | | 9.3 | 11.9 |
| Zinc salt of | 0.4 | 0.4 | 0.4 | 0.4 | 0.4 | 0.4 | 0.4 | 0.25 | 0.25 | 0.3 | 0.3 | 0.3 |
| pentachlorothiophenol | | | | | | | | | | | | |
| Vulcanization | 158 | 158 | 153 | 150 | 150 | 150 | 150 | 158 | 158 | 145 | 155 | 155 |
| temperature (° C.) | | | | | | | | | | | | |
| Vulcanization time (min) | 18 | 18 | 18 | 21 | 21 | 21 | 21 | 16 | 16 | 19 | 15 | 15 |

The details of each component described in Table 1 are as follows.
Polybutadiene A: Trade name “BR 01” (manufactured by ENEOS Materials Corporation)
Polybutadiene B: Trade name “BR T700” (manufactured by ENEOS Materials Corporation)
Zinc acrylate A: Trade name “ZN-DA85S” (manufactured by Nippon Shokubai Co., Ltd.)
Zinc acrylate B: Trade name “ZN-DA85SR” (manufactured by Nippon Shokubai Co., Ltd.)
Zinc stearate: Trade name “Zinc stearate GP” (manufactured by NOF Corporation)
Organic peroxide A: Dicumyl peroxide, trade name “Percumyl D” (manufactured by NOF Corporation)
Organic peroxide B: A mixture of 1,1-di(t-butylperoxy)cyclohexane and silica, trade name “Perhexa C-40” (manufactured by NOF Corporation)
Sulfur: Trade name “SANMIX S-80N” (manufactured by Sanshin Chemical Industry Co., Ltd.), sulfur masterbatch containing 80 wt % of sulfur powder for rubber
Water: Pure water (manufactured by Seiki Co., Ltd.)
Antioxidant A: 2,2-methylenebis(4-methyl-6-butylphenol), trade name “Nocrac NS-6” (manufactured by Ouchi Shinko Chemical Industrial Co., Ltd.)
Antioxidant B: 2-mercaptobenzimidazole, trade name “Nocrac MB” (manufactured by Ouchi Shinko Chemical Industrial Co., Ltd.)
Antioxidant C: Trade name “ANTAGE HP-500” (manufactured by Kawaguchi Chemical Industry Co., Ltd.)
Zinc oxide: Trade name “Grade 3 Zinc Oxide” (manufactured by Sakai Chemical Industry Co., Ltd.)
Zinc salt of pentachlorothiophenol: Manufactured by FUJIFILM Wako Pure Chemical Corporation

### [Formation of Intermediate Layer and Cover (Outermost Layer)]

Next, in Examples 1 and 2 and Comparative Examples 1 to 4, the intermediate layer was formed by injection molding the resin material No. 1 or No. 2 of the intermediate layer shown in Table 2 around the core surface using an injection mold. Next, using a separate injection mold, injection molding was performed with the resin material No. 5 or No. 6 of the cover (outermost layer) shown in Table 2 around the intermediate layer-encased sphere to form the cover. At this time, a predetermined large number of dimples described below were formed on the surface of the cover.

In Example 3 and Comparative Examples 5 to 9, the intermediate layer is formed by injection molding the resin material No. 1, No. 3, or No. 4 of the intermediate layer shown in Table 2 around the core surface using an injection mold. Subsequently, the cover is formed by injection molding the resin material No. 5 of the cover (outermost layer) shown in Table 2 around the intermediate layer-encased sphere using a separate injection mold. At this time, a large number of predetermined dimples described below are formed on the cover surface.

TABLE 2

| Resin composition | High-acid | | | | | | | |
|---|---|---|---|---|---|---|---|---|
| (pbw) | ionomer | Type of metal | No. 1 | No. 2 | No. 3 | No. 4 | No. 5 | No. 6 |
| Himilan 1605 | N/A | Na | | | 50 | | | |
| Himilan 1557 | N/A | Zn | | 15 | 15 | | | |
| Himilan 1706 | N/A | Zn | 15 | | 35 | 15 | | |
| AM7318 | Applicable | Na | 85 | 85 | | 85 | | |
| S9320 | N/A | Zn | | | | | | |
| Titanium oxide | | | 1.6 | 1.6 | | | 3.0 | 3.0 |
| Barium sulfate | | | 20 | 20 | | | | |
| Trimethylolpropane | | | 1.1 | 1.1 | 1.1 | 1.1 | | |
| Polyethylene wax | | | 0.7 | 0.7 | | | | |
| TPU (1) | | | | | | | 100 | |
| TPU (2) | | | | | | | | 100 |

Details of the blending components in Table 2 are as follows.
“Himilan 1605”, “Himilan 1557”, “Himilan 1706”, and “AM7329” ionomer resins manufactured by Dow-Mitsui Polychemicals Co., Ltd.
“S9320” ionomer resin manufactured by The Dow Chemical Company
Trade name “Precipitated Barium Sulfate 300” barium sulfate manufactured by Sakai Chemical Industry Co., Ltd.
“Trimethylolpropane” (TMP) manufactured by Tokyo Chemical Industry Co., Ltd.
Polyethylene wax, trade name “Sun Wax 161-P” manufactured by Sanyo Chemical Industries, Ltd.
Trade name “Pandex” ether-type thermoplastic polyurethane (TPU(1)), material hardness (Shore D) 47, manufactured by DIC Covestro Polymer Ltd.
Trade name “Pandex” ether-type thermoplastic polyurethane (TPU(2)), material hardness (Shore D) 43, manufactured by DIC Covestro Polymer Ltd.

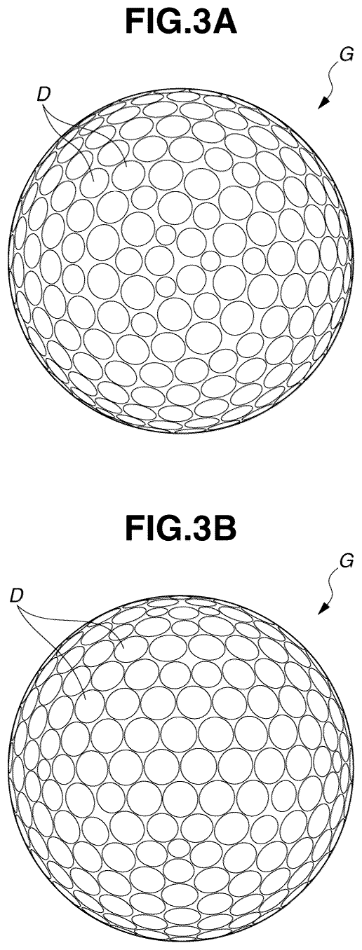

For the dimples of Examples and Comparative Examples, the following common dimple mode was used. This dimple mode includes eight types of circular dimples of No. 1 to No. 8 having different diameters and depths. Details thereof are listed in Table 3 below. In addition, this dimple arrangement mode (pattern) is illustrated in FIGS. 3A and 3B. FIG. 3A is a plan view of the dimples, and FIG. 3B is a side view thereof.

TABLE 3

| | | Diameter | Depth | Volume | Cylinder volume | SR | |
|---|---|---|---|---|---|---|---|
| Dimple | Number | (mm) | (mm) | (mm³) | ratio | (%) | VR |
| No. 1 | 12 | 4.63 | 0.122 | 1.009 | 0.491 | 84 | 0.68 |
| No. 2 | 198 | 4.50 | 0.119 | 0.919 | 0.486 | | |
| No. 3 | 36 | 3.92 | 0.115 | 0.655 | 0.472 | | |
| No. 4 | 12 | 2.87 | 0.086 | 0.245 | 0.442 | | |
| No. 5 | 36 | 4.49 | 0.126 | 0.965 | 0.483 | | |
| No. 6 | 24 | 3.92 | 0.124 | 0.711 | 0.473 | | |
| No. 7 | 6 | 3.31 | 0.133 | 0.550 | 0.479 | | |
| No. 8 | 6 | 3.21 | 0.132 | 0.457 | 0.430 | | |
| Total | 330 | | | | | | |

[Definition of Dimples]
Edge: Highest point in cross-section passing through the center of the dimple.
Diameter: Diameter of the flat plane circumscribed by the edge of the dimple.
Depth: Maximum depth of the dimple from the flat plane circumscribed by the edge of the dimple.
SR: Ratio of the sum of the individual dimple surface areas, each defined by the flat plane circumscribed by the edge of the dimple, to the ball spherical surface area on the assumption that the ball has no dimples.
Dimple volume: Volume of the dimple under the flat plane circumscribed by the edge of the dimple.
Cylinder volume ratio: Ratio of the dimple volume to the volume of a cylinder having a depth with the same diameter as the dimple.
VR: Ratio of the sum of volumes of the individual dimples formed below the flat plane circumscribed by the edge of the dimple to the ball spherical volume on the assumption that the ball has no dimples.

For each resulting golf ball, various physical properties such as internal hardnesses at various positions of the core, outer diameters of the core and each layer-encased sphere, thicknesses and material hardnesses of each layer, and deflections and surface hardnesses of each layer-encased sphere are evaluated by the following methods, and are shown in Tables 4 and 5.

### [Outer Diameter of Each Sphere of Core and Intermediate Layer-Encased Sphere]

After being temperature-adjusted to 23.9±1° C. for at least three hours in a thermostatic bath, the sphere to be measured is measured in a room at a temperature of 23.9±2° C. Five random places on the surface are measured, and using an average value of these measurements as a measured value of each sphere, an average value for the diameter of 10 such spheres is determined.

### [Ball Diameter]

After being temperature-adjusted to 23.9±1° C. for at least three hours in a thermostatic bath, the ball to be measured is measured in a room at a temperature of 23.9±2° C. Fifteen random places on a portion with no dimples are measured, and using an average value of these measurements as a measured value of one ball, an average value for the diameter of 10 such balls is determined.

### [Deflections of Core, Intermediate Layer-Encased Sphere, and Ball]

The subject spheres of the core, intermediate layer-encased sphere, or ball is placed on a hard plate, and the deflection when compressed under a final load of 1,275 N (130 kgf) from an initial load of 98 N (10 kgf) is measured. The deflection is a measured value after the temperature is adjusted to 23.9° C. A pressing speed of a head that compresses the ball is set to 10 mm/s.

### [Core Hardness Profile]

The core surface is spherical, but an indenter of a durometer is set substantially perpendicular to the spherical core surface, and a core surface hardness expressed on the Shore C hardness scale is measured in accordance with ASTM D2240. With respect to the core center and a predetermined position of the core, the core is cut into hemispheres to obtain a flat cross-section, the hardness is measured by perpendicularly pressing the indenter of the durometer against a center portion and the predetermined positions shown in Table 4, and the hardnesses at the center and each position are shown as Shore C hardness values. For the measurement of the hardness, a P2 Automatic Rubber Hardness Tester manufactured by Kobunshi Keiki Co., Ltd. equipped with a Shore C durometer is used. For the hardness value, a maximum value is read. All measurements are carried out in an environment of 23±2° C. The numerical values in Table 6 are Shore C hardness values.

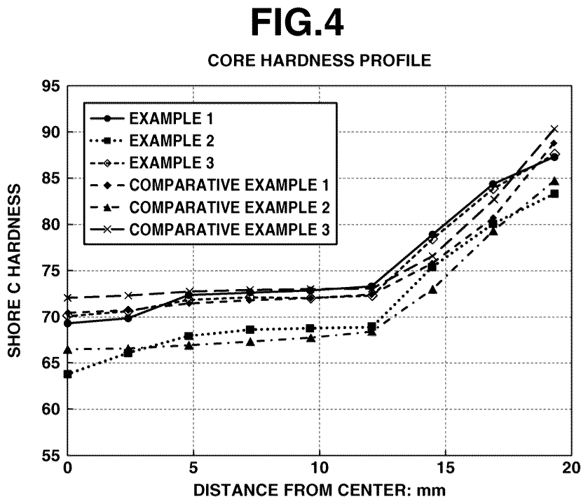

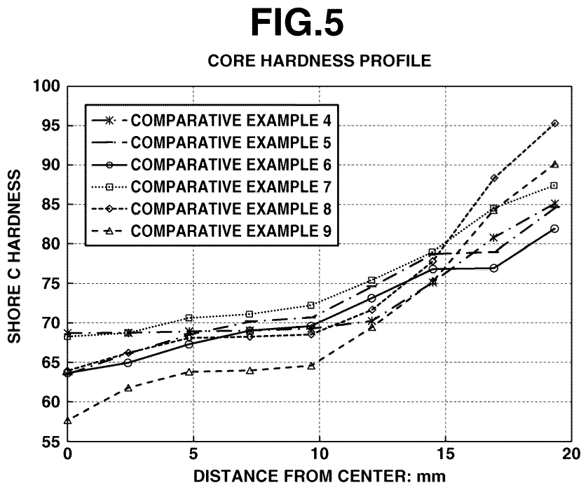

In addition, FIG. 4 and FIG. 5 show graphs of core hardness profiles for Examples 1 to 4 and Comparative Examples 1 to 9.

### [Material Hardnesses of Intermediate Layer and Cover]

The resin material of each layer is molded into a sheet having a thickness of 2 mm and left for two weeks. Thereafter, the Shore D hardness and the Shore C hardness are measured in accordance with the ASTM D2240 standard. For the measurement of the hardness, the P2 Automatic Rubber Hardness Tester manufactured by Kobunshi Keiki Co., Ltd. is used. Shore D hardness and Shore C hardness attachments are attached to measure each hardness. For the hardness value, a maximum value is read. All measurements are carried out in an environment of 23±2° C.

### [Surface Hardnesses of Each Sphere of Intermediate Layer-Encased Sphere and of Ball]

Measurement is performed by perpendicularly pressing the indenter against the surface of each sphere. Note that the surface hardness of the ball (cover) is a measured value at a dimple-free area (land) on the surface of the ball. The Shore D hardness and the Shore C hardness are measured in accordance with the ASTM D2240 standard. For the measurement of the hardness, the P2 Automatic Rubber Hardness Tester manufactured by Kobunshi Keiki Co., Ltd. is used. Shore D hardness and Shore C hardness attachments are attached to measure each hardness. For the hardness value, a maximum value is read. All measurements are carried out in an environment of 23±2° C.

TABLE 4

| | | Example | | | Comparative Example | | | | | | | | |
|---|---|---|---|---|---|---|---|---|---|---|---|---|---|
| | | 1 | 2 | 3 | 1 | 2 | 3 | 4 | 5 | 6 | 7 | 8 | 9 |
| Core | Outer diameter (mm) | 38.63 | 38.63 | 38.63 | 38.57 | 38.63 | 38.66 | 38.63 | 38.68 | 38.67 | 38.62 | 38.64 | 38.63 |
| | Weight (g) | 34.34 | 34.19 | 34.34 | 34.13 | 34.23 | 34.45 | 34.30 | 35.14 | 35.14 | 34.96 | 34.97 | 35.01 |
| | Specific gravity | 1.14 | 1.13 | 1.14 | 1.14 | 1.13 | 1.14 | 1.14 | 1.16 | 1.16 | 1.16 | 1.16 | 1.16 |
| | Deflection (mm) | 3.06 | 3.64 | 3.06 | 3.13 | 3.57 | 3.00 | 3.56 | 2.84 | 3.13 | 2.92 | 3.18 | 3.74 |
| Core | H100 (surface) | 87.2 | 83.2 | 87.5 | 88.7 | 84.6 | 90.2 | 85.2 | 84.6 | 81.9 | 87.4 | 95.4 | 90.2 |
| hardness | H87.5 | 84.2 | 80.0 | 83.8 | 80.7 | 79.1 | 82.6 | 80.9 | 79.0 | 77.0 | 84.4 | 88.4 | 84.4 |
| profile | H75 | 78.7 | 75.3 | 78.4 | 75.7 | 72.9 | 76.5 | 75.1 | 78.8 | 76.9 | 79.0 | 77.9 | 75.4 |
| (Shore C | H62.5 | 73.1 | 68.8 | 72.2 | 72.3 | 68.3 | 73.0 | 70.3 | 74.6 | 73.1 | 75.4 | 71.8 | 69.4 |
| hardness) | H50 (intermediate) | 72.7 | 68.6 | 72.0 | 71.9 | 67.6 | 72.9 | 69.3 | 70.7 | 69.5 | 72.2 | 68.5 | 64.6 |
| | H37.5 | 72.5 | 68.5 | 71.9 | 71.7 | 67.2 | 72.8 | 69.0 | 70.2 | 69.0 | 71.1 | 68.2 | 64.0 |
| | H25 | 72.2 | 67.8 | 71.7 | 71.4 | 66.8 | 72.6 | 69.0 | 68.5 | 67.3 | 70.6 | 68.1 | 63.8 |
| | H12.5 | 69.7 | 66.0 | 70.5 | 70.6 | 66.4 | 72.2 | 68.7 | 66.2 | 65.0 | 68.7 | 66.3 | 61.8 |
| | H0 (center) | 69.2 | 63.6 | 70.0 | 70.4 | 66.3 | 72.0 | 68.7 | 63.5 | 63.6 | 68.3 | 63.9 | 57.8 |
| | H100 − H87.5 | 3.0 | 3.2 | 3.7 | 8.0 | 5.5 | 7.6 | 4.3 | 5.6 | 4.9 | 3.0 | 7.0 | 5.8 |
| | H87.5 − H75 | 5.5 | 4.7 | 5.4 | 5.0 | 6.2 | 6.1 | 5.8 | 0.2 | 0.1 | 5.4 | 10.5 | 9.0 |
| | H75 − H62.5 | 5.6 | 6.5 | 6.2 | 3.4 | 4.6 | 3.5 | 4.8 | 4.2 | 3.8 | 3.6 | 6.1 | 6.0 |
| | H62.5 − H50 | 0.4 | 0.2 | 0.2 | 0.4 | 0.7 | 0.1 | 1.0 | 3.9 | 3.6 | 3.2 | 3.3 | 4.8 |
| | H50 − H37.5 | 0.2 | 0.1 | 0.1 | 0.2 | 0.4 | 0.1 | 0.3 | 0.5 | 0.5 | 1.1 | 0.3 | 0.6 |
| | H37.5 − H25 | 0.3 | 0.7 | 0.2 | 0.3 | 0.4 | 0.2 | 0.0 | 1.7 | 1.7 | 0.5 | 0.1 | 0.2 |
| | H25 − H12.5 | 2.5 | 1.8 | 1.2 | 0.8 | 0.4 | 0.4 | 0.3 | 2.3 | 2.3 | 1.9 | 1.8 | 2.0 |
| | H12.5 − H0 | 0.5 | 2.4 | 0.5 | 0.2 | 0.1 | 0.2 | 0.0 | 2.7 | 1.4 | 0.4 | 2.4 | 4.0 |
| | H100 − H0 | 18.0 | 19.6 | 17.5 | 18.3 | 18.3 | 18.2 | 16.5 | 21.1 | 18.3 | 19.1 | 31.5 | 32.4 |
| | H87.5 − H0 | 15.0 | 16.4 | 13.8 | 10.3 | 12.8 | 10.6 | 12.2 | 15.5 | 13.4 | 16.1 | 24.5 | 26.6 |
| | H100 − H75 | 8.5 | 7.9 | 9.1 | 13.0 | 11.7 | 13.7 | 10.1 | 5.8 | 5.0 | 8.4 | 17.5 | 14.8 |
| | H75 − H50 | 6.0 | 6.7 | 6.4 | 3.8 | 5.3 | 3.6 | 5.8 | 8.1 | 7.4 | 6.8 | 9.4 | 10.8 |
| | H50 − H25 | 0.5 | 0.8 | 0.3 | 0.5 | 0.8 | 0.3 | 0.3 | 2.2 | 2.2 | 1.6 | 0.4 | 0.8 |
| | H25 − H0 | 3.0 | 4.2 | 1.7 | 1.0 | 0.5 | 0.6 | 0.3 | 5.0 | 3.7 | 2.3 | 4.2 | 6.0 |
| | (H75 − H62.5) − (H87.5 − H75) | 0.1 | 1.8 | 0.8 | −1.6 | −1.6 | −2.6 | −1.0 | 4.0 | 3.7 | −1.8 | −4.4 | −3.0 |
| | (H87.5 − H75) − (H100 − H87.5) | 2.5 | 1.5 | 1.7 | −3.0 | 0.7 | −1.5 | 1.5 | −5.4 | −4.8 | 2.4 | 3.5 | 3.2 |
| | (H100 − H87.5) − (H62.5 − H50) | 2.6 | 3.0 | 3.5 | 7.6 | 4.8 | 7.5 | 3.3 | 1.7 | 1.3 | −0.2 | 3.7 | 1.0 |
| | (H87.5 − H50)/(H50 − H12.5) | 3.83 | 4.38 | 7.87 | 6.77 | 9.58 | 13.86 | 19.33 | 1.84 | 1.67 | 3.49 | 9.05 | 7.07 |
| | (H100 − H50)/(H50 − H0) | 4.14 | 2.92 | 7.75 | 11.20 | 13.08 | 19.22 | 26.50 | 1.93 | 2.10 | 3.90 | 5.85 | 3.76 |
| | (H100 − H87.5)/(H87.5 − H75) | 0.55 | 0.68 | 0.69 | 1.60 | 0.89 | 1.25 | 0.74 | 28.00 | 49.00 | 0.56 | 0.67 | 0.64 |
| | (H87.5 − H75)/(H75 − H62.5) | 0.98 | 0.72 | 0.87 | 1.47 | 1.35 | 1.74 | 1.21 | 0.05 | 0.03 | 1.50 | 1.72 | 1.50 |

TABLE 5

| | | Example | | | Comparative Example | | | | | | | | |
|---|---|---|---|---|---|---|---|---|---|---|---|---|---|
| | | 1 | 2 | 3 | 1 | 2 | 3 | 4 | 5 | 6 | 7 | 8 | 9 |
| Structure (piece) | | 3P | 3P | 3P | 3P | 3P | 3P | 3P | 3P | 3P | 3P | 3P | 3P |
| Intermediate | Material | No. 1 | No. 1 | No. 1 | No. 1 | No. 1 | No. 2 | No. 2 | No. 3 | No. 3 | No. 4 | No. 3 | No. 3 |
| layer | Thickness (mm) | 1.22 | 1.20 | 1.22 | 1.24 | 1.20 | 1.20 | 1.21 | 1.19 | 1.19 | 1.21 | 1.22 | 1.23 |
| | Specific gravity | 1.09 | 1.09 | 1.09 | 1.09 | 1.09 | 1.09 | 1.09 | 0.95 | 0.95 | 0.95 | 0.95 | 0.95 |
| | Surface hardness | 95 | 95 | 95 | 95 | 95 | 94 | 94 | 94 | 94 | 94 | 94 | 94 |
| | (Shore C) | | | | | | | | | | | | |
| | Surface hardness | 68 | 68 | 68 | 68 | 68 | 68 | 68 | 66 | 66 | 67 | 66 | 66 |
| | (Shore D) | | | | | | | | | | | | |
| Intermediate | Outer diameter | 41.06 | 41.02 | 41.06 | 41.05 | 41.03 | 41.05 | 41.04 | 41.05 | 41.05 | 41.03 | 41.07 | 41.09 |
| layer- | (mm) | | | | | | | | | | | | |
| encased | Weight (g) | 40.84 | 40.60 | 40.84 | 40.76 | 40.72 | 40.83 | 40.80 | 40.70 | 40.68 | 40.65 | 40.75 | 40.77 |
| sphere | Deflection (mm) | 2.55 | 3.04 | 2.55 | 2.61 | 2.92 | 2.52 | 2.99 | 2.55 | 2.76 | 2.53 | 2.55 | 2.68 |
| | Surface hardness | 98 | 98 | 98 | 98 | 98 | 98 | 98 | 97 | 97 | 97 | 97 | 97 |
| | (Shore C) | | | | | | | | | | | | |
| | Surface hardness | 71 | 71 | 71 | 71 | 71 | 71 | 71 | 70 | 70 | 70 | 70 | 70 |
| | (Shore D) | | | | | | | | | | | | |
| Intermediate layer surface | | 11 | 15 | 11 | 9 | 13 | 8 | 13 | 12 | 15 | 10 | 2 | 7 |
| hardness - Core surface | | | | | | | | | | | | | |
| hardness (Shore C) | | | | | | | | | | | | | |
| Intermediate layer surface | | 29 | 34 | 28 | 28 | 32 | 26 | 29 | 34 | 33 | 29 | 33 | 39 |
| hardness - Core center | | | | | | | | | | | | | |
| hardness (Shore C) | | | | | | | | | | | | | |
| Cover | Material | No. 5 | No. 5 | No. 5 | No. 5 | No. 5 | No. 6 | No. 6 | No. 5 | No. 5 | No. 5 | No. 5 | No. 5 |
| | Thickness (mm) | 0.82 | 0.85 | 0.82 | 0.83 | 0.84 | 0.82 | 0.83 | 0.83 | 0.83 | 0.82 | 0.82 | 0.81 |
| | Specific gravity | 1.12 | 1.12 | 1.12 | 1.12 | 1.12 | 1.12 | 1.12 | 1.12 | 1.12 | 1.12 | 1.12 | 1.12 |
| | Surface hardness | 72 | 72 | 72 | 72 | 72 | 65 | 65 | 72 | 72 | 72 | 72 | 72 |
| | (Shore C) | | | | | | | | | | | | |
| | Surface hardness | 47 | 47 | 47 | 47 | 47 | 43 | 43 | 47 | 47 | 47 | 47 | 47 |
| | (Shore D) | | | | | | | | | | | | |
| Ball | Outer diameter | 42.71 | 42.72 | 42.71 | 42.70 | 42.72 | 42.69 | 42.70 | 42.71 | 42.70 | 42.68 | 42.72 | 42.70 |
| | (mm) | | | | | | | | | | | | |
| | Weight (g) | 45.60 | 45.55 | 45.60 | 45.60 | 45.64 | 45.60 | 45.55 | 45.50 | 45.48 | 45.40 | 45.51 | 45.46 |
| | Deflection (mm) | 2.41 | 2.77 | 2.41 | 2.39 | 2.74 | 2.37 | 2.77 | 2.39 | 2.61 | 2.40 | 2.44 | 2.84 |
| | Surface hardness | 89 | 89 | 89 | 89 | 89 | 87 | 87 | 89 | 89 | 89 | 89 | 89 |
| | (Shore C) | | | | | | | | | | | | |
| | Surface hardness | 60 | 60 | 60 | 60 | 60 | 59 | 59 | 60 | 60 | 60 | 60 | 60 |
| | (Shore D) | | | | | | | | | | | | |
| Hardness | Intermediate layer | 9 | 9 | 9 | 9 | 9 | 11 | 11 | 8 | 8 | 8 | 8 | 8 |
| relationships | surface hardness - | | | | | | | | | | | | |
| | Ball surface | | | | | | | | | | | | |
| | hardness (Shore C) | | | | | | | | | | | | |
| | Intermediate layer | 11 | 11 | 11 | 11 | 11 | 12 | 12 | 10 | 10 | 10 | 10 | 10 |
| | surface hardness - | | | | | | | | | | | | |
| | Ball surface | | | | | | | | | | | | |
| | hardness (Shore D) | | | | | | | | | | | | |
| | Ball surface | 2 | 6 | 2 | 0 | 4 | −3 | 2 | 4 | 7 | 2 | −6 | −1 |
| | hardness - Core | | | | | | | | | | | | |
| | surface hardness | | | | | | | | | | | | |
| | (Shore C) | | | | | | | | | | | | |
| | Ball surface | 20 | 25 | 19 | 19 | 23 | 15 | 18 | 26 | 25 | 21 | 25 | 31 |
| | hardness - Core | | | | | | | | | | | | |
| | center hardness | | | | | | | | | | | | |
| | (Shore C) | | | | | | | | | | | | |
| Core diameter/Ball diameter | | 0.904 | 0.904 | 0.904 | 0.903 | 0.904 | 0.906 | 0.905 | 0.906 | 0.906 | 0.905 | 0.904 | 0.905 |
| (Intermediate layer | | 0.39 | 0.35 | 0.39 | 0.41 | 0.36 | 0.38 | 0.37 | 0.35 | 0.36 | 0.38 | 0.39 | 0.43 |
| thickness) - (Cover | | | | | | | | | | | | | |
| thickness) (mm) | | | | | | | | | | | | | |
| (Core deflection) - | | 0.65 | 0.87 | 0.65 | 0.74 | 0.83 | 0.63 | 0.79 | 0.45 | 0.52 | 0.52 | 0.74 | 0.90 |
| (Ball deflection) (mm) | | | | | | | | | | | | | |
| (Core deflection)/(Ball | | 1.27 | 1.31 | 1.27 | 1.31 | 1.30 | 1.27 | 1.29 | 1.19 | 1.20 | 1.22 | 1.30 | 1.32 |
| deflection) | | | | | | | | | | | | | |
| Specific | Cover specific | 0.03 | 0.03 | 0.03 | 0.03 | 0.03 | 0.03 | 0.03 | 0.17 | 0.17 | 0.17 | 0.17 | 0.17 |
| gravity | gravity - | | | | | | | | | | | | |
| relationships | Intermediate layer | | | | | | | | | | | | |
| | material | | | | | | | | | | | | |
| | specific gravity | | | | | | | | | | | | |
| | Intermediate layer | −0.05 | −0.04 | −0.05 | −0.05 | −0.04 | −0.05 | −0.05 | −0.21 | −0.21 | −0.21 | −0.21 | −0.21 |
| | material specific | | | | | | | | | | | | |
| | gravity - Core | | | | | | | | | | | | |
| | specific gravity | | | | | | | | | | | | |
| | Core specific | 0.02 | 0.01 | 0.02 | 0.02 | 0.01 | 0.02 | 0.02 | 0.04 | 0.04 | 0.04 | 0.04 | 0.04 |
| | gravity - Cover | | | | | | | | | | | | |
| | material specific | | | | | | | | | | | | |
| | gravity | | | | | | | | | | | | |

The flight (W #1) (I #6), the spin rate on approach shots, and the durability on repeated impact of each golf ball are evaluated by the following methods. The results are shown in Table 6.

[Evaluation of Flight (W #1, HS 50 m/s)]

The driver is mounted on a golf swing robot, and a spin rate and a distance traveled (total) by a ball when struck at a head speed (HS) of 50 m/s are measured. The club used is a TOUR B XD-5 Driver/loft angle 8.5° (2017 model) manufactured by Bridgestone Sports Co., Ltd. and is evaluated according to the following rating criteria.

### <Rating Criteria>

Very good: Total distance compared with Comparative Example 1 is more than +2.0 m.
Good: Total distance compared with Comparative Example 1 is at least-1.0 m and not more than +2.0 m.
Fair: Total distance compared with Comparative Example 1 is at least-2.0 m and less than-1.0 m.
NG: Total distance compared with Comparative Example 1 is less than-2.0 m.
   [Evaluation of Flight (W #1, HS 45 m/s)]

The driver is mounted on the golf swing robot, and the spin rate and the distance traveled (total) by a ball when struck at a head speed (HS) of 45 m/s are measured. The club used is a J015 Driver/loft angle 9.5° (2016 model) manufactured by Bridgestone Sports Co., Ltd. and is evaluated according to the following rating criteria.

### <Rating Criteria>

Very good: Total distance compared with Comparative Example 1 is more than +2.0 m.
Good: Total distance compared with Comparative Example 1 is at least-1.0 m and not more than +2.0 m.
Fair: Total distance compared with Comparative Example 1 is at least-2.0 m and less than-1.0 m.
NG: Total distance compared with Comparative Example 1 is less than-2.0 m.
   [Evaluation of Flight (I #6, HS 42 m/s)]

A number six iron (I #6) is mounted on the golf swing robot, and the spin rate and the distance traveled (total) by a ball when struck at a head speed (HS) of 42 m/s are measured. The club used is a JGR Forged I #6 (2016 model) manufactured by Bridgestone Sports Co., Ltd. and is evaluated according to the following rating criteria.

### <Rating Criteria>

Very good: Total distance compared with Comparative Example 1 is more than +2.0 m.
Good: Total distance compared with Comparative Example 1 is at least-1.0 m and not more than +2.0 m.
Fair: Total distance compared with Comparative Example 1 is at least-2.0 m and less than-1.0 m.
NG: Total distance compared with Comparative Example 1 is less than-2.0 m.

### [Evaluation of Spin Rate on Approach Shots]

A judgment is made based on a spin rate when a sand wedge is mounted on the golf swing robot and a ball is struck at an HS of 15 m/s. Similarly, a spin rate immediately after the ball is struck is measured by a device for measuring initial conditions. The sand wedge used is a TOURSTAGE TW-03 (loft angle 57°) 2002 model manufactured by Bridgestone Sports Co., Ltd.

### <Rating Criteria>

Very good: Spin rate is more than 5,500 rpm
Good: Spin rate is more than 5,200 rpm and not more than 5,500 rpm
Fair: Spin rate is more than 4,900 rpm and not more than 5,200 rpm
NG: Spin rate is not more than 4,900 rpm

### [Durability on Repeated Impact]

A durability of the golf ball is evaluated using an ADC Ball COR Durability Tester produced by Automated Design Corporation (U.S.). The tester has a function of firing a golf ball pneumatically and causing the golf ball to repeatedly strike two metal plates installed in parallel. The incident velocity on the metal plates is set to 43 m/s. The number of times of firing required until the golf ball cracks is measured, and an average value of the measured values of 10 golf balls is calculated. The following criteria are used for the evaluation.

### <Rating Criteria>

Very good: More than 300 firings
Good: More than 200 and less than 300 firings
Fair: More than 120 and less than 200 firings
NG: Not more than 120 firings

TABLE 6

| | | | Example | | | Comparative Example | | |
|---|---|---|---|---|---|---|---|---|
| | | | 1 | 2 | 3 | 1 | 2 | 3 |
| Flight | W#1 | Spin rate (rpm) | 2,516 | 2,412 | 2,541 | 2,596 | 2,411 | 2,759 |
| | HS | Total (m) | 279.5 | 277.6 | 279.0 | 275.8 | 275.1 | 276.6 |
| | 50 m/s | Total in comparison | 3.7 | 1.8 | 3.2 | 0 | −0.7 | 0.8 |
| | | with Comparative | | | | | | |
| | | Example 1 (m) | | | | | | |
| | | Rating | Very | Good | Very | Good | Good | Good |
| | | | good | | good | | | |
| | W#1 | Spin rate (rpm) | 2,945 | 2,855 | 2,974 | 3,026 | 2,883 | 3,263 |
| | HS | Total (m) | 245.5 | 241.7 | 245.1 | 242.6 | 241.7 | 240.8 |
| | 45 m/s | Total in comparison | 2.9 | −0.9 | 2.5 | 0 | −0.9 | −1.8 |
| | | with Comparative | | | | | | |
| | | Example 1 (m) | | | | | | |
| | | Rating | Very | Good | Very | Good | Good | Fair |
| | | | good | | good | | | |
| | I#6 | Spin rate (rpm) | 5,344 | 4,885 | 5,397 | 5,469 | 4,947 | 6,025 |
| | HS | Total (m) | 180.1 | 183.5 | 179.8 | 180.1 | 182.1 | 178.9 |
| | 42 m/s | Total in comparison | 0 | 3.4 | −0.3 | 0 | 2.0 | −1.2 |
| | | with Comparative | | | | | | |
| | | Example 1 (m) | | | | | | |
| | | Rating | Good | Very | Good | Good | Good | Fair |
| | | | | good | | | | |
| Approach | SW | Spin rate (rpm) | 5,279 | 5,241 | 5,332 | 5,310 | 5,279 | 5,550 |
| shots | HS | Rating | Good | Good | Good | Good | Good | Very |
| | 15 m/s | | | | | | | good |
| Durability | Number of firings | | 373 | 240 | 336 | 275 | 242 | 273 |
| to repeated | Rating | | Very | Good | Very | Good | Good | Good |
| impact | | | good | | good | | | |
| Rating | Flight | W#1 HS 50 m/s | 3 | 2 | 3 | 2 | 2 | 2 |
| (score) | | W#1 HS 45 m/s | 3 | 2 | 3 | 2 | 2 | 1 |
| | | I#6 HS 42 m/s | 2 | 3 | 2 | 2 | 2 | 1 |
| | Spin performance | | 2 | 2 | 2 | 2 | 2 | 3 |
| | on approach shots | | | | | | | |
| | Durability to repeated impact | | 3 | 2 | 3 | 2 | 2 | 2 |
| | Total | | 13 | 11 | 13 | 10 | 10 | 9 |
| | | | Comparative Example | | | | | |
| | | | 4 | 5 | 6 | 7 | 8 | 9 |
| Flight | W#1 | Spin rate (rpm) | 2,629 | 2,691 | 2,601 | 2,619 | 2,437 | 2,336 |
| | HS | Total (m) | 273.6 | 276.7 | 276.7 | 276.0 | 279.7 | 278.6 |
| | 50 m/s | Total in comparison | −2.2 | 0.9 | 0.9 | 0.2 | 3.9 | 2.8 |
| | | with Comparative | | | | | | |
| | | Example 1 (m) | | | | | | |
| | | Rating | NG | Good | Good | Good | Very | Very |
| | | | | | | | good | good |
| | W#1 | Spin rate (rpm) | 3,079 | 3,107 | 2,975 | 3,053 | 2,792 | 2,676 |
| | HS | Total (m) | 241.6 | 242.3 | 242.4 | 243 | 244.9 | 243.9 |
| | 45 m/s | Total in comparison | −1.0 | −0.3 | −0.2 | 0.4 | 2.3 | 1.3 |
| | | with Comparative | | | | | | |
| | | Example 1 (m) | | | | | | |
| | | Rating | Good | Good | Good | Good | Very | Good |
| | | | | | | | good | |
| | I#6 | Spin rate (rpm) | 5,427 | 5,688 | 5,360 | 5,405 | 5,082 | 4,768 |
| | HS | Total (m) | 182.1 | 177.1 | 178.6 | 180.2 | 181.2 | 183.9 |
| | 42 m/s | Total in comparison | 2.0 | −3.0 | −1.5 | 0.1 | 1.1 | 3.8 |
| | | with Comparative | | | | | | |
| | | Example 1 (m) | | | | | | |
| | | Rating | Good | NG | Fair | Good | Good | Very |
| | | | | | | | | good |
| Approach | SW | Spin rate (rpm) | 5,423 | 5,340 | 5,224 | 5,345 | 5,402 | 5,337 |
| shots | HS | Rating | Good | Good | Good | Good | Good | Good |
| | 15 m/s | | | | | | | |
| Durability | Number of firings | | 233 | 283 | 182 | 190 | 87 | 56 |
| to repeated | Rating | | Good | Good | Fair | Fair | NG | NG |
| impact | | | | | | | | |
| Rating | Flight | W#1 HS 50 m/s | 0 | 2 | 2 | 2 | 3 | 3 |
| (score) | | W#1 HS 45 m/s | 2 | 2 | 2 | 2 | 3 | 2 |
| | | I#6 HS 42 m/s | 2 | 0 | 1 | 2 | 2 | 3 |

| | | | | | | |
|---|---|---|---|---|---|---|
| Spin performance | 2 | 2 | 2 | 2 | 2 | 2 |
| on approach shots | | | | | | |
| Durability to repeated impact | 2 | 2 | 1 | 1 | 0 | 0 |
| Total | 8 | 8 | 8 | 9 | 10 | 10 |

* Rating scores are counted as 3 points for “Very good (⊚)”, 2 points for “Good (◯)”, 1 point for “Fair (Δ)”, and 0 points for “NG (X)”.

As shown in the results in Table 6, the golf balls of Comparative Examples 1 to 9 are inferior in the following respects to the golf balls according to the present invention (Examples).

In Comparative Example 1, in the hardness profile of the core, (H87.5−H75) was larger than (H75−H62.5), and (H100−H87.5) was larger than (H87.5−H75), and as a result, the flight on full shots or the durability on repeated impact was inferior to that of the Examples.

In Comparative Example 2, in the hardness profile of the core, (H87.5−H75) was larger than (H75−H62.5), and as a result, the flight on full shots or the durability on repeated impact was inferior to that of the Examples.

In Comparative Example 3, in the hardness profile of the core, (H87.5−H75) was larger than (H75−H62.5), and (H100−H87.5) was larger than (H87.5−H75), and as a result, the flight on full shots or the durability on repeated impact was inferior to that of the Examples.

In Comparative Example 4, in the hardness profile of the core, (H87.5−H75) was larger than (H75−H62.5), and as a result, the flight on full shots or the durability on repeated impact was inferior to that of the Examples.

In Comparative Example 5, in the hardness profile of the core, (H100−H87.5) is larger than (H87.5−H75), and (H87.5−H50)/(H50−H12.5) is smaller than 3.0. As a result, the flight on full shots is inferior to that of the Examples.

In Comparative Example 6, in the hardness profile of the core, (H100−H87.5) is larger than (H87.5−H75), and (H87.5−H50)/(H50−H12.5) is smaller than 3.0. As a result, the flight on full shots or the durability on repeated impact is inferior to that of the Examples.

In Comparative Example 7, in the hardness profile of the core, (H87.5−H75) is larger than (H75−H62.5), and (H62.5−H50) is larger than (H100−H87.5), and as a result, the flight on full shots or the durability on repeated impact is inferior to that of the Examples.

In Comparative Example 8, in the hardness profile of the core, the value of (H87.5−H75) is larger than 7.0, and the value of (H87.5−H75) is larger than (H75−H62.5), and as a result, the durability on repeated impact is inferior to that of the Examples.

In Comparative Example 9, in the hardness profile of the core, the value of (H87.5−H75) is larger than 7.0, and the value of (H87.5−H75) is larger than (H75−H62.5), and as a result, the durability on repeated impact is inferior to that of the Examples.

Japanese Patent Application No. 2024-162381 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a single-layer core and a cover, wherein the core has a hardness profile in which, letting a Shore C hardness of a surface of the core be H100, a Shore C hardness at a position outside by 87.5% of a core radius from a core center be H87.5, a Shore C hardness at a position outside by 75% of the core radius from the core center be H75, a Shore C hardness at a position outside by 62.5% of the core radius from the core center be H62.5, a Shore C hardness at a position outside by 50% of the core radius from the core center be H50, a Shore C hardness at a position outside by 37.5% of the core radius from the core center be H37.5, a Shore C hardness at a position outside by 25% of the core radius from the core center be H25, a Shore C hardness at a position outside by 12.5% of the core radius from the core center be H12.5, and a Shore C hardness at the core center be H0, the following two conditions are satisfied:
$$0 \leq ( H 62.5 - H 50 ) < ( H 100 - H 87.5 ) < ( H 87.5 - H 75 ) < ( H 75 - H 62.5 ) \leq 7. and$$
$$( H 87.5 - H 50 ) / ( H 50 - H 1 2.5 ) \geq 3.0 .$$

2. The golf ball of claim 1, wherein the following condition is satisfied:
$$( H 100 - H 87.5 ) / ( H 87.5 - H 75 ) \leq 0.90 .$$

3. The golf ball of claim 1, wherein the following condition is satisfied:
$$0.5 \leq ( H 87.5 - H 75 ) / ( H 75 - H 62.5 ) \leq 0.99 .$$

4. The golf ball of claim 1, wherein the following condition is satisfied:
$$1. \leq ( H 100 - H 87.5 ) \leq 6.0 .$$

5. The golf ball of claim 1, wherein the following condition is satisfied:
$$2. \leq ( H 87.5 - H 75 ) \leq 6.5 .$$

6. The golf ball of claim 1 wherein the following condition is satisfied:
$$4. \leq ( H 75 - H 62.5 ) \leq 7.0 .$$

7. The golf ball of claim 1, wherein the following condition is satisfied:
$$0 \leq ( H 62.5 - H 50 ) \leq 3.0 .$$

8. The golf ball of claim 1, wherein the following condition is satisfied:
$$0 \leq ( H 50 - H 25 ) \leq 3.0 .$$

9. The golf ball of claim 1, wherein values of the following eight conditions are all positive values:
H100−H87.5,
H87.5−H75,
H75−H62.5,
H62.5−H50,
H50−H37.5,
H37.5−H25,
H25−H12.5, and
H12.5−H0.

10. The golf ball of claim 1, wherein the core is formed of a rubber composition including the following components (a) to (e):
(a) a base rubber,
(b) an α,β-unsaturated carboxylic acid and/or a metal salt thereof as a co-crosslinking agent,
(c) an organic peroxide,
(d) water or a moisture-providing agent, and
(e) a hindered phenol-based antioxidant having a substituent having a thioether structure, the moisture-providing agent being a substance that contains a water component other than free water in a structure thereof and desorbs moisture by heating, or a substance that releases a water component by thermal decomposition by heating, a compounding amount of the component (e) being at least 0.2 parts by weight per 100 parts by weight of the component (a).

11. The golf ball of claim 10, wherein the hindered phenol-based antioxidant that is the component (e) has a chemical structure having at least one methyl group at an ortho position.

12. The golf ball of claim 10, wherein the hindered phenol-based antioxidant that is the component (e) has at least two substituents having a thioether structure.

13. The golf ball of claim 1, wherein a deflection when the core is compressed under a final load of 1,275 N (130 kgf) from an initial load of 98 N (10 kgf) is not more than 3.8 mm.

14. The golf ball of claim 1, wherein when a deflection when the core is compressed under a final load of 1,275 N (130 kgf) from an initial load of 98 N (10 kgf) is A (mm), and a deflection when the golf ball is compressed under a final load of 1,275 N (130 kgf) from an initial load of 98 N (10 kgf) is B (mm), a value of A-B is less than 1.0 mm.

15. The golf ball of claim 1, which is a three-piece or more golf ball comprising a resin intermediate layer interposed between the core and the cover, wherein a relationship between a surface hardness of a sphere (intermediate layer-encased sphere) obtained by encasing the core with the intermediate layer and a surface hardness of the ball satisfies the following condition:
(Shore D hardness of surface of intermediate layer-encased sphere)−(Shore D hardness of surface of ball)≥3.
